(19) United States
(12) Patent Application Publication
(10) Pub. No.: US 2025/0390776 A1
(43) Pub. Date: Dec. 25, 2025

(54) TRAINING KERNELS FOR FREQUENCY-MULTIPLEXED QUANTUM BIT READOUT

(71) Applicant: International Business Machines Corporation, Armonk, NY (US)

(72) Inventors: George Russell Zettles, IV, Rochester, MN (US); Timothy Lindquist, Rochester, MN (US); Jarrett Betke, Hoffman Estates, IL (US); Austin Carter, Olmsted, MN (US); George Paulik, Rochester, MN (US); Daniel Ramirez, Rochester, MN (US); Bryce Snell, Rochester, MN (US); Kevin Daniel Escobar, Rochester, MN (US)

(21) Appl. No.: 18/753,096

(22) Filed: Jun. 25, 2024

(51) Int. Cl. G06N 10/40

(52) U.S. Cl. CPC G06N 10/40

(57) ABSTRACT

Techniques are provided for training kernels for use in frequency-multiplexed readout of quantum bits. For example, a method comprises performing multiple iterations of a process which comprises setting states of a group of quantum bits using a random process, and performing a readout process to acquire a frequency-multiplexed readout signal which represents readout states of the group of quantum bits. The frequency-multiplexed readout signals that are acquired for at least a portion of the iterations are analyzed to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

### BACKGROUND

This disclosure relates generally to quantum computing and, in particular, quantum systems and devices which implement a frequency-multiplexed readout system for reading the quantum states of superconducting quantum bits (qubits). A superconducting quantum computing system is implemented using circuit quantum electrodynamics (QED) devices, which utilize the quantum dynamics of electromagnetic fields in superconducting circuits, which include superconducting qubits, to generate and process quantum information. In general, superconducting qubits are electronic circuits which are implemented using components such as superconducting tunnel junctions (e.g., Josephson junctions), inductors, and/or capacitors, etc., and which behave as quantum mechanical anharmonic (non-linear) oscillators with quantized states, when cooled to cryogenic temperatures. A qubit can be effectively operated as a two-level system using computational basis states (e.g., a ground state |0 [symbol] and a first excited state |0 [symbol] ) of the qubit, due to the anharmonicity imparted by a non-linear inductor element (e.g., Josephson inductance) of the qubit, which allows the ground and first-excited states to be uniquely addressed at a transition frequency of the qubit, without significantly disturbing the higher-excited states of the qubit.

In a relatively large quantum computing system, a frequency-multiplexed readout system can be implemented for reading the quantum states of multiplexed groups of qubits, which enables scaling the number of qubit readout signals per readout chain, while minimizing the number of readout signal chains that need to be implemented in the quantum computing system. In a frequency-multiplexed readout system, multiple readout resonators (with different resonance frequencies) are coupled dispersively to separate qubits, and commonly coupled to a shared readout bus. The shared readout bus is configured to allow the transmission of multiple readout signals with readout frequencies which correspond to the resonance frequencies of the readout resonators, and, thus simultaneously read out the quantum states of multiple qubits using one input and one output line. The ability to implement a high-performance frequency-multiplexed readout system is non-trivial as frequency-multiplexed readout of multiple qubits is susceptible to crosstalk-induced qubit-state-readout errors, which can lead to degraded readout fidelity.

### SUMMARY

Exemplary embodiments of the disclosure include techniques for training kernels for use in frequency-multiplexed readout of quantum bits.

For example, an exemplary embodiment includes a method which comprises performing multiple iterations of a process which comprises setting states of a group of quantum bits using a random process, and performing a readout process to acquire a frequency-multiplexed readout signal which represents readout states of the group of quantum bits. The frequency-multiplexed readout signals that are acquired for at least a portion of the iterations are analyzed to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

Another exemplary embodiment includes a computer program product for performing a process to train kernels for use in frequency-multiplexed readout of quantum bits. The computer program product comprises one or more computer readable storage media, and program instructions collectively stored on the one or more computer readable storage media. The program instructions comprise program instructions to perform multiple iterations of a process which comprises: setting states of a group of quantum bits using a random process; and performing a readout process to acquire a frequency-multiplexed readout signal which represents readout states of the group of quantum bits, and program instructions to analyze the frequency-multiplexed readout signals acquired for at least a portion of the iterations to build at least one kernel for each quantum bit of the group of quantum bits. The at least one kernel for a given quantum bit is configured for use in discriminating a state of the given quantum bit in a frequency-multiplexed readout operation applied to the group of quantum bits.

Another exemplary embodiment includes a device which comprises a memory and processing circuitry. The memory is configured to store program instructions. The processing circuitry is coupled to the memory, and is configured to execute the program instructions to train kernels for use in frequency-multiplexed readout of quantum bits. The training comprises performing multiple iterations of a process which comprises setting states of a group of quantum bits using a random process, and performing a readout process to acquire a frequency-multiplexed readout signal which represents readout states of the group of quantum bits. The frequency-multiplexed readout signals acquired for at least a portion of the iterations are analyzed to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

Other embodiments will be described in the following detailed description of exemplary embodiments, which is to be read in conjunction with the accompanying figures.

### BRIEF DESCRIPTION OF THE DRAWINGS

FIG. 1 schematically illustrates a frequency-multiplexed readout system for reading quantum states of superconducting qubits, according to an exemplary embodiment of the disclosure.

FIG. 2A schematically illustrates a hardware discriminator which is configured to utilize trained kernels to analyze a frequency-multiplexed readout signal to discriminate quantum states of qubits, according to an exemplary embodiment of the disclosure.

FIG. 2B schematically illustrates a hardware discriminator which is configured to utilize trained kernels to analyze a frequency-multiplexed readout signal to discriminate quantum states of qubits, according to another exemplary embodiment of the disclosure.

FIG. 3 is a flow diagram which illustrates a method for utilizing trained kernels to analyze a frequency-multiplexed readout signal to discriminate quantum states of qubits, according to another exemplary embodiment of the disclosure.

FIG. 4 schematically illustrates a method to discriminate quantum states of a given qubit, according to an exemplary embodiment of the disclosure.

FIGS. 5A and 5B are flow diagrams which illustrate a method for training a group of kernels that are configured to analyze frequency-multiplexed readout signals for a group of qubits to discriminate quantum states of the qubits, according to an exemplary embodiment of the disclosure.

FIG. 6 illustrates a flow diagram of a method for training a group of kernels that are configured to analyze frequency-multiplexed readout signals for a group of qubits to discriminate quantum states of the qubits, according to another exemplary embodiment of the disclosure.

FIG. 7 schematically illustrates an exemplary architecture of a computing environment that is configured to implement kernel training methods, according to an exemplary embodiment of the disclosure.

FIG. 8A is a schematic block diagram of an exemplary hybrid computing system that can be configured to implement kernel training methods to facilitate frequency-multiplexed readout of quantum states of superconducting qubits, according to an exemplary embodiment of the disclosure.

FIG. 8B is a schematic block diagram of an exemplary architecture, and data transmission, of a hybrid computing system employed using a cloud architecture for a classical backend, according to an exemplary embodiment of the disclosure.

### DETAILED DESCRIPTION

Exemplary embodiments of the disclosure will now be described in further detail with regard to techniques for training kernels for use in frequency-multiplexed readout of qubits.

For example, an exemplary embodiment includes a method which comprises performing multiple iterations of a process which comprises setting states of a group of qubits using a random process, and performing a readout process to acquire a frequency-multiplexed readout signal which represents readout states of the group of qubits. The frequency-multiplexed readout signals that are acquired for at least a portion of the iterations are analyzed to build at least one kernel for each qubit of the group of qubits, wherein the at least one kernel for a given qubit is configured for use in discriminating a state of the given qubit in a frequency-multiplexed readout operation applied to the group of qubits.

Advantageously, exemplary embodiments of the disclosure implement kernel training techniques in which multiple kernels are trained in parallel. For example, with a frequency-multiplexed readout system, the kernels for a multiplexed group of N qubits are trained in parallel using information derived from frequency-multiplexed readout signals which include readout signals of the N qubits, in a randomized manner. The parallel kernel training process allows each kernel for each qubit to be constructed in way that takes into consideration the individual contributions and interactions (e.g., cross-talk) of other readout signals of other qubits in the multiplexed group of N qubits, thereby rendering each kernel for each qubit to be effective in discerning/extracting corresponding qubit readout signals from the frequency-multiplexed readout signal. In addition, an exemplary parallel kernel training process allows the kernels of the qubits to be effectively built using significantly less training iterations, as compared to a process of training one kernel per qubit at a time.

In another exemplary embodiment, which may be combined with one or more of the embodiments of the preceding paragraphs, setting the states of the group of qubits using a random process comprises randomly setting the state of a given qubit to be one of a ground state, an excited state, and an inactive state.

In another exemplary embodiment, which may be combined with one or more of the embodiments of the preceding paragraphs, the random process is implemented using a pseudo random number generator.

In another exemplary embodiment, which may be combined with one or more of the embodiments of the preceding paragraphs, the random process is implemented using a true random number generator.

In another exemplary embodiment, which may be combined with one or more of the embodiments of the preceding paragraphs, performing multiple iterations of the process further comprises performing multiple iterations of a single qubit readout process which comprises: setting the state of a single qubit of the group of qubits to a given computational basis state; and performing a readout process to acquire a readout signal which represents the readout state of the single qubit.

In another exemplary embodiment, which may be combined with one or more of the embodiments of the preceding paragraphs, the at least one kernel for each qubit comprises a digital representation of a sinusoidal waveform having a frequency that corresponds to a readout resonator that is associated with the qubit.

In another exemplary embodiment, which may be combined with one or more of the embodiments of the preceding paragraphs, analyzing the frequency-multiplexed readout signals acquired for at least a portion of the iterations to build at least one kernel for each qubit of the group of qubits, comprises: determining a first subset of the iterations in which a given qubit was set to a ground state; determining a second subset of the iterations in which the given qubit was set to an excited state; computing a first average of the frequency-multiplexed readout signals acquired in the first subset of the iterations; computing a second average of the frequency-multiplexed readout signals acquired in the second subset of the iterations; and building the at least one kernel for the given qubit based on the computed first average and the computed second average.

In another exemplary embodiment, which may be combined with one or more of the embodiments of the preceding paragraphs, building the at least one kernel for the given qubit comprises determining the at least one kernel based at least in part on a difference between the computed first average and the computed second average.

Another exemplary embodiment includes a computer program product for performing a process to train kernels for use in frequency-multiplexed readout of qubits. The computer program product comprises one or more computer readable storage media, and program instructions collectively stored on the one or more computer readable storage media. The program instructions comprise program instructions to perform multiple iterations of a process which comprises: setting states of a group of qubits using a random process; and performing a readout process to acquire a frequency-multiplexed readout signal which represents readout states of the group of qubits, and program instructions to analyze the frequency-multiplexed readout signals acquired for at least a portion of the iterations to build at least one kernel for each qubit of the group of qubits. The at least one kernel for a given qubit is configured for use in discriminating a state of the given qubit in a frequency-multiplexed readout operation applied to the group of qubits.

In another exemplary embodiment, which may be combined with one or more of the embodiments of the preceding paragraphs, the program instructions for setting the states of the group of qubits using a random process comprises program instructions to randomly set the state of a given qubit to be one of a ground state, an excited state, and an inactive state.

In another exemplary embodiment, which may be combined with one or more of the embodiments of the preceding paragraphs, the random process is implemented using a pseudo random number generator or a true random number generator.

In another exemplary embodiment, which may be combined with one or more of the embodiments of the preceding paragraphs, the program instructions to perform multiple iterations of the process further comprise program instruction to perform multiple iterations of a single readout process which comprises: setting the state of a single qubit of the group of qubits to a given computational basis state; and performing a readout process to acquire a readout signal which represents the readout state of the single qubit.

In another exemplary embodiment, which may be combined with one or more of the embodiments of the preceding paragraphs, the at least one kernel for each qubit comprises a digital representation of a sinusoidal waveform having a frequency that corresponds to a readout resonator that is associated with the qubit.

In another exemplary embodiment, which may be combined with one or more of the embodiments of the preceding paragraphs, the program instructions to analyze the frequency-multiplexed readout signals acquired for at least a portion of the iterations to build at least one kernel for each qubit of the group of qubits, comprise: program instructions to determine a first subset of the iterations in which a given qubit was set to a ground state; program instructions to determine a second subset of the iterations in which the given qubit was set to an excited state; program instructions to compute a first average of the frequency-multiplexed readout signals acquired in the first subset of the iterations; program instructions to compute a second average of the frequency-multiplexed readout signals acquired in the second subset of the iterations; and program instruction to build the at least one kernel for the given qubit based on the computed first average and the computed second average.

In another exemplary embodiment, which may be combined with one or more of the embodiments of the preceding paragraphs, the program instructions to build the at least one kernel for the given qubit comprise program instructions to determine the at least one kernel based at least in part on a difference between the computed first average and the computed second average.

In another exemplary embodiment, which may be combined with one or more of the embodiments of the preceding paragraphs, the program instructions further comprise program instructions to configure a kernel training process on a quantum computing system comprising a group of physical qubits with corresponding readout resonators that are coupled to a shared readout bus, to train kernels for use in frequency-multiplexed readout of the group of physical qubits, based on parameters of a computer simulated kernel training process.

Another exemplary embodiment includes a device which comprises a memory and processing circuitry. The memory is configured to store program instructions. The processing circuitry is coupled to the memory, and is configured to execute the program instructions to train kernels for use in frequency-multiplexed readout of qubits. The training comprises performing multiple iterations of a process which comprises setting states of a group of qubits using a random process, and performing a readout process to acquire a frequency-multiplexed readout signal which represents readout states of the group of qubits. The frequency-multiplexed readout signals acquired for at least a portion of the iterations are analyzed to build at least one kernel for each qubit of the group of qubits, wherein the at least one kernel for a given qubit is configured for use in discriminating a state of the given qubit in a frequency-multiplexed readout operation applied to the group of qubits.

In another exemplary embodiment, which may be combined with one or more of the embodiments of the preceding paragraphs, setting the states of the group of qubits using a random process comprises randomly setting the state of a given qubit to be one of a ground state, an excited state, and an inactive state.

In another exemplary embodiment, which may be combined with one or more of the embodiments of the preceding paragraphs, the random process is implemented using at least one of a pseudo random number generator and a true random number generator.

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise quantum circuit elements (e.g., qubits, coupler circuitry, etc.), discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

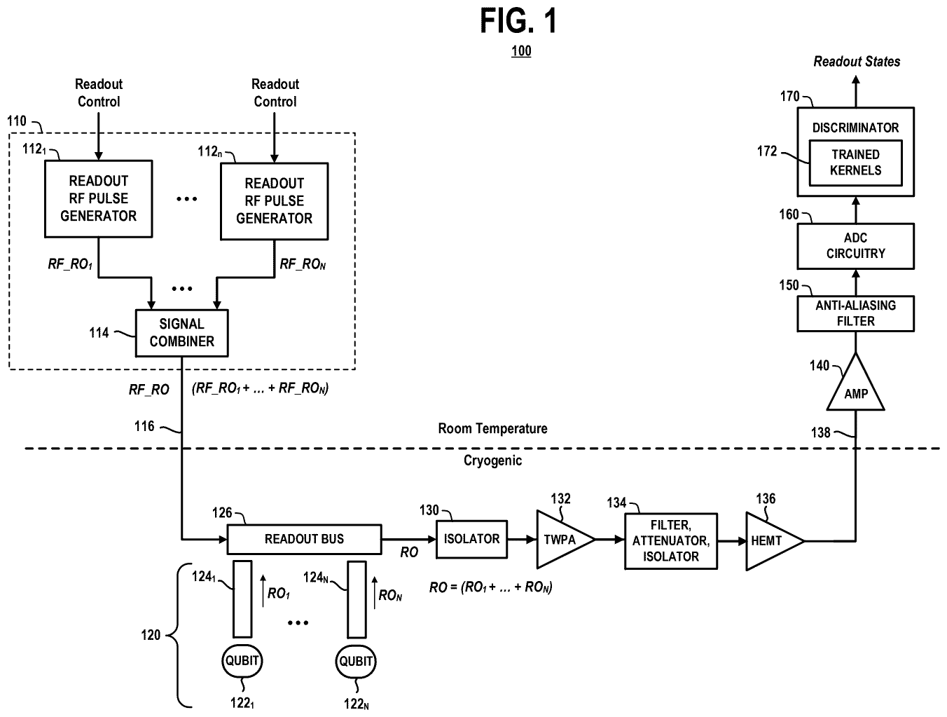

FIG. 1 schematically illustrates a frequency-multiplexed readout system for reading quantum states of superconducting qubits, according to an exemplary embodiment of the disclosure. In particular, FIG. 1 schematically illustrates a frequency-multiplexed readout system 100 which is configured to implement frequency-domain multiplexing to scale-up a readout chain in a quantum computing system for concurrently reading out the quantum states of a group of superconducting qubits in relatively large superconducting quantum computers. The frequency-multiplexed readout system 100 comprises a readout control system 110, a first high-bandwidth transmission line 116, a qubit-resonator system 120 which is coupled to a readout bus 126, and a readout signal chain which comprises various components including, but not limited to, an isolator 130, a traveling wave parametric amplifier (TWPA) 132, filter, attenuator, and isolator components 134, a high-electron-mobility transistor (HEMT) amplifier 136, a second high-bandwidth transmission line 138, an amplifier 140, an anti-aliasing filter 150, an analog-to-digital converter (ADC) circuitry 160, and a discriminator 170 which utilizes trained kernels 172 to determine qubit states, the details of which will be explained in further detail below.

In some embodiments, the readout control system 110, the amplifier 140, the anti-aliasing filter 150, the ADC circuitry 160, and the discriminator 170 are implemented using electronics which operate in a room temperature (RT) environment, while the qubit-resonator system 120, the readout bus 126, the isolator 130, the TWPA 132, the filter, attenuator, and isolator components 134, and the HEMT amplifier 136 are electronic components that operate in a cryogenic environment within a cryogenic cooling chamber (e.g., a multi-stage cryostat or dilution refrigerator). For example, in some embodiments, the qubit-resonator system 120, the readout bus 126, the isolator 130, the TWPA 132, and the filter, attenuator, and isolator components 134 operate in cryogenic environments at temperatures less than 100 millikelvin (mK), while the HEMT amplifier 136 operates in a cryogenic environment of 3K-4K. In some embodiments, the qubit-resonator system 120 and the readout bus 126 are disposed on the same quantum chip, while the other microwave components 130, 132, 134, and 136 are disposed off-chip. The frequency-multiplexed readout system 100 implements a N:1 frequency domain multiplexing scheme to readout the quantum states of N superconducting qubits using one readout signal chain, and two high-bandwidth I/O transmission lines (e.g., the first and second high-bandwidth transmission lines 116 and 138).

The qubit-resonator system 120 comprises a plurality (N) of superconducting qubits 1221, . . . , 122N (generally, superconducting qubits 122), and a plurality (N) of corresponding readout resonators 1241, . . . , 124N (generally readout resonators 124). As schematically illustrated in FIG. 1, each superconducting qubit 1221, . . . , 122N is coupled (e.g., capacitively coupled) to a respective one of the readout resonators 1241, . . . , 124N. Further, in some embodiments, the readout resonators 1241, . . . , 124N are commonly coupled (e.g., capacitively coupled) to the readout bus 126. The superconducting qubit 1221, . . . , 122N comprise a group of N qubits (or N frequency-multiplexed qubits) having quantum states that can be concurrently readout using the exemplary N:1 multiplexing scheme as schematically illustrated in FIG. 1. The number N of qubits that can be included within a given group can be 2 or greater (e.g., N=10, N=20, etc.). For a given quantum processor comprising a qubit array (or qubit lattice) having a total of X qubits, the qubits can be partitioned into, e.g., X/N groups of frequency-multiplexed qubits.

The superconducting qubits 122 may comprise any type of superconducting qubit including, but not limited to, transmon qubits, fluxonium qubits, superconducting multimode qubits, etc. In some embodiments, the superconducting qubits 122 comprise respective qubit transition frequencies (e.g., on the order of GHz) which are detuned (i.e., transition frequencies that are close but separated by, e.g., 100 MHz or 200 MHZ, etc.), depending on the particular implementation scheme of a qubit array and quantum processor. As noted above, the transition frequency (alternatively, resonant frequency) of a superconducting qubit is the frequency that corresponds to a difference in the energy between the ground state |0 [symbol] and the first excited state |1 [symbol] of the qubit. The superconducting qubits can be designed to have a relatively high anharmonic spectrum, in which the frequency separation between the computational states and the non-computational states, is relatively high, allowing efficient use of a superconducting qubit as a two-level quantum system. The term “anharmonicity” refers to a difference between (i) the frequency (f₀₁) to transition from the ground state |0 [symbol] to the first excited state |1 [symbol] and (ii) the frequency (f₁₂) to transition from first excited state |1 [symbol] to the second excited state |2 [symbol] , of the qubit.

In some embodiments, the readout resonators 1241, . . . , 124N comprise transmission line readout resonators (e.g., half-wavelength coplanar waveguide resonators), which are utilized to readout the quantum states of the respective superconducting qubits 1221, . . . , 122N using dispersive readout techniques, which are well-known to those of ordinary skill in the art. The readout resonators 1241, . . . , 124N are configured to have respective resonant frequencies f₁, . . . , f_{N}, which are different (e.g., achieved by different electrical lengths of the readout resonators 1241, . . . , 124N), and which are detuned from the respective transition frequencies of the superconducting qubits 122₁, . . . , 122_{N} to enable a dispersive readout of the qubit states. In an exemplary embodiment, the readout resonators 1241, . . . , 124N are configured to have respective resonant frequencies f₁, . . . , f_{N} with center frequencies that differ by a minimum resonator frequency separation Δf parameter where Δf is in a range of, e.g., 50 MHz to 100 MHz, and resonator bandwidths of, e.g., 2-5 MHz centered about the resonant frequencies. By way of example, in an exemplary non-limiting embodiment, assume that N=10 and that Δf=60 MHz. In this instance, the readout resonators 124₁, . . . , 124_{N}=10 could be configured to have respective resonant (center) frequencies f₁, . . . , f_{N}=10 (in GHz) of: 6.56, 6.62, 6.68, 6.74, 6.80, 6.86, 6.92, 6.98, 7.04, and 7.10 GHz, covering a readout bandwidth of 540 MHz (7.10 GHz-6.56 GHz).

It is to be noted that while not specifically shown in FIG. 1, the qubit-resonator system 120 can implement Purcell filters which couple the readout resonators 124₁, . . . , 124_{N} to the shared readout bus 126. Each qubit-resonator system can introduce an unwanted decay channel for the given superconducting qubit due to energy leakage through the given readout resonator into the shared readout bus 126, as a result of a phenomenon known as the Purcell effect which is one of a plurality of limiting factors for high-fidelity qubit readout. The Purcell filters are configured to reduce residual off-resonant energy decay from the qubits to the resonators. The Purcell filters allow the readout resonators to have relatively large bandwidths to increase coupling between each readout resonator and the shared readout bus and thereby increase readout speed, while suppressing the Purcell effect (energy decay). In this regard, the Purcell filters enhance the coherence times (T1) of the superconducting qubits, which could otherwise be limited by large readout resonator bandwidths in the absence of the Purcell filters.

The readout control system 110 comprises a plurality (N) of readout radio frequency (RF) pulse generators 112₁, . . . , 112_{N}, and a signal combiner 114. The readout radio frequency (RF) pulse generators 112₁, . . . , 112_{N} are configured to generate respective RF readout control signals, RF_RO₁, . . . , RF_RO_{N}, which are configured to readout the states of the superconducting qubits 122₁, . . . , 122_{N}, respectively, using frequency multiplexing and dispersive readout techniques. The RF readout control signals RF_RO₁, . . . , RF_RO_{N} comprise respective frequencies which match the resonance frequencies of the respective readout resonators 124₁, . . . , 124_{N}. More specifically, each RF readout control signal RF_RO₁, . . . , RF_RO_{N} comprises a single frequency tone that is the same or similar to the resonant frequency of the corresponding one of the readout resonators 124₁, . . . , 124_{N}, a pulse envelope with a given pulse shape (e.g., gaussian pulse envelope), and given pulse duration.

As schematically shown in FIG. 1, the signal combiner 114 comprises input terminals that are coupled to output terminals of the readout RF pulse generators 112₁, . . . , 112_{N}. The signal combiner 114 is configured to combine (or superimpose) the RF readout control signals, RF_RO₁, . . . , RF_RO_{N} into a multi-frequency RF readout control RF_RO, which is output from the signal combiner 114 and applied to the first high-bandwidth transmission line 116. The multi-frequency RF readout control RF_RO is transmitted on the first high-bandwidth transmission line 116 (from room temperature) to the readout bus 126 in the cryogenic cooling chamber. The multi-frequency RF readout control RF_RO is the sum of the individual RF readout control signals, RF_RO=RF_RO₁+ . . . +RF_RO_{N}, which are generated and output from the readout RF pulse generators 112₁, . . . , 112_{N} at a given time.

The readout control system 110 can be implemented using various signal generator architectures and techniques. For example, in some embodiments, the readout control system 110 is implemented using heterodyne mixing techniques. More specifically, in some embodiments, each readout RF pulse generator 112₁, . . . , 112_{N} comprises (i) a waveform generator (or pulse envelope generator), which comprises a digital-to-analog converter (DAC) circuit, (ii) a low-pass filter circuit coupled to an output of the waveform generator, and (iii) an I/Q mixer coupled to an output of the low-pass filter circuit. The waveform generator is configured to generate and output analog I and Q control signals with a given type of pulse envelope (e.g., Gaussian square pulse envelope) for qubit state readout, in response to a readout control signal. The analog I and Q control pulses are filtered by the low-pass filter circuitry. The filtered analog control I and Q control pulses are applied to the I/Q mixer, along with quadrature LO signals that are generated using known LO signal generation techniques. The I/Q mixer is configured to mix the analog I and Q control pulses with the quadrature LO signals at a given LO frequency to perform I/Q modulation, and up-conversion and/or down-conversion using known techniques (e.g., single sideband modulation) to generate a given RF readout control signal RF_ROi.

In other embodiments, the readout control system 110 is implemented using direct RF generation techniques. More specifically, in some embodiments, the readout control system 110 can implement a plurality of digital frequency generators (e.g., numerically controlled oscillators (NCOs)) which are configured to generate respective discretized sine wave signal having respective RF frequencies based on low-frequency digital clock signals that are input to the digital frequency generators, using techniques that are well-known to those of ordinary skill in the art. Moreover, with direct RF generation, each readout RF pulse generator 112₁, . . . , 112_{N} may comprise a DAC circuit which comprises a digital mixer and a filter, wherein the digital mixer is configured to mix a given discretized sine wave signal (output from a given NCO) with an intermediate frequency (IF) signal representing a pulse envelope, and wherein the output of the mixer is filtered by the filter to generate a given RF readout control signal RF_ROi. In addition, for direct RF generation, each readout RF pulse generator 112₁, . . . , 112_{N} may comprise a bandpass filter and amplifier, which are configured to bandpass filter and amplify the output of the DAC circuit.

For illustrative purposes, FIG. 1 shows N individual readout RF pulse generators 112₁, . . . , 112_{N}, which are configured to generate respective ones of the RF readout control signals RF_RO₁, . . . , RF_RO_{N}. However, in some embodiments, a given readout RF pulse generator can be configured to generate a plurality of RF readout control signals. For example, in a direct RF generation system as described above, a single DAC circuit can be configured to generate two or more or all of the RF readout control signals RF_RO₁, . . . , RF_RO_{N} by intentional aliasing of signals into higher Nyquist zones. For example, for a given DAC circuit with a sampling frequency fₛ, the DAC circuit will generate a frequency of

$$\frac{{f}_{s}}{2}$$

in the first Nyquist zone and generate higher frequencies in the second Nyquist zone

$$( 2 \times \frac{{f}_{s}}{2} ) ,$$

the third Nyquist zone

$$( 3 \times \frac{{f}_{s}}{2} ) ,$$

etc. While the alias signals will have reduced power, the RF readout control signals that are output from a given DAC circuit are amplified (room temperature amplifier) before being transmitted to the cryogenic cooling system.

With the exemplary frequency-multiplexed readout system 100 shown in FIG. 1, the readout of the superconducting qubits 122₁, . . . , 122_{N} is realized using a dispersive regime of qubit-resonator coupling, wherein individual readout signals from the readout resonators 124₁, . . . , 124_{N} are output on the shared readout bus 126 to generate a frequency-multiplexed readout signal RO which is processed on a single readout channel to determine quantum states of superconducting qubits 122₁, . . . , 122_{N}. In general, in the dispersive regime of qubit-resonator coupling, a readout control signal (e.g., microwave signal with a requisite frequency, pulse envelope shape (e.g., gaussian pulse envelope), and pulse duration) is applied to a given readout resonator that is coupled to a given superconducting qubit. The readout control signal interacts with the given qubit/resonator system in a manner which results in the generation of a resulting readout signal that is reflected out from the readout resonator, wherein the readout signal comprises information (e.g., phase and amplitude information) that is qubit-state dependent. More specifically, in the dispersive readout regime, the qubit states |0 [symbol] and |1 [symbol] cause different shifts in the resonance frequency of the readout resonator, wherein the shift in frequency of the readout resonator is determined by measuring the phase of the readout pulse reflected out from the readout resonator. In other words, the dispersive readout process of a given superconducting qubit yields a readout signal having a state-dependent phasor response, which is analyzed to discriminate the quantum state of the superconducting qubit (e.g., the quantum state of the qubit can be inferred from the amplitude and phase of the readout signal).

Although not specifically shown in FIG. 1, each of the superconducting qubits 122₁, . . . , 122_{N} would be coupled (e.g., capacitively coupled) to a corresponding, dedicated qubit drive line. The qubit drive line that is coupled to a given superconducting qubit is configured to apply control signals (e.g., microwave control pulse signals) to independently change the state of the given superconducting qubit. For example, a microwave control pulse can be applied to the qubit drive line to perform a single-qubit gate operation on the superconducting qubit or otherwise modify the computational state of the superconducting qubit, as needed, when executing a quantum algorithm. As is known in the art, the state of a superconducting qubit can be changed by applying a microwave control signal (e.g., control pulse) with a center frequency equal to a transition frequency of the qubit, wherein the axis of rotation about a given axis of the Bloch sphere (e.g., X-axis, Y-axis, or any axis in the X-Y plane) and the amount (angle) of such rotation are based, respectively, on the phase of the microwave control signal, and the amplitude and duration of the microwave control signal.

In the context of the frequency-multiplexed readout system 100 shown in FIG. 1, a frequency-multiplexed readout operation generally involves (i) applying a multi-frequency RF readout control RF_RO to the shared readout bus 126 to probe the readout resonators 124₁, . . . , 124_{N}, which are coupled to the respective superconducting qubits 122₁, . . . , 122_{N}, and which are dispersively coupled to the shared readout bus 126, (ii) acquiring a frequency-multiplexed readout signal RO which comprises a combination of respective readout signals RO₁, . . . , RO_{N} that are reflected out from the readout resonators 124₁, . . . , 124_{N} onto the shared readout bus 126 in response to the multi-frequency RF readout control RF_RO, and (iii) discriminating the frequency-multiplexed readout signal RO using trained kernels to infer the quantum states of the superconducting qubits 122₁, . . . , 122_{N}.

More specifically, as schematically shown in FIG. 1, the multi-frequency RF readout control RF_RO is generated by the readout control system 110 and transmitted on the first high-bandwidth transmission line 116 into the cryogenic cooling chamber and applied to the shared readout bus 126. As noted above, to readout the quantum states of the N superconducting qubits 122₁, . . . , 122_{N}, the multi-frequency RF readout control RF_RO would comprise a combination of multiple RF readout control signals RF_RO₁, . . . , RF_RO_{N} (e.g., RF_RO=RF_RO₁+ . . . +RF_RO_{N}), wherein the RF readout control signals RF_RO₁, . . . , RF_RO_{N} have respective frequencies that correspond to the resonant frequencies of the respective readout resonators 124₁, . . . , 124_{N}.

In response to the multi-frequency RF readout control signal RF_RO on the shared readout bus 126, the readout resonators 124₁, . . . , 124_{N} would interact with the respective the superconducting qubits 122₁, . . . , 122_{N}, and generate respective readout signals RO₁, . . . , RO_{N}, which are reflected out from the readout resonators 124₁, . . . , 124_{N} and coupled onto the shared readout bus 126 and combined to generate the frequency-multiplexed readout signal RO. The frequency-multiplexed readout signal RO comprises information (amplitude changes and phase shifts, or lack of amplitude changes or phase shifts) which is indicative of the quantum states of the superconducting qubits 122₁, . . . , 122_{N}.

In the dispersive regime, the transition frequency of the qubit is far detuned from the resonant frequency of the readout resonator, such that that frequency of the readout resonator is weakly dependent on the state of the qubit. Such detuning is designed to decouple the qubit from a readout bus which is coupled to the readout resonator and thereby minimize a Purcell decay channel which, in turn, decreases the probability of qubit relaxation through the readout resonator via a Purcell decay process. On the other hand, a fast and high-fidelity readout of the qubit state requires strong coupling between the resonator and environment, which leads to conflicting requirements of the properties of the readout resonator with regard to efficient readout and qubit isolation. In some embodiments, a Purcell filter comprises a bandpass filter that is configured to suppress signal propagation at the transition frequency of the superconducting qubit (and thereby suppress spontaneous emission of the qubit energy through the Purcell effect), while allowing signal propagation at the readout signal frequency.

The frequency-multiplexed readout signal RO is transmitted along the portion of the readout signal path (or readout channel) within the cryogenic cooling chamber which comprises the isolator 130, the TWPA 132, the filter, attenuator, and isolator components 134, and the HEMT amplifier 136. The TWPA 132 comprises a quantum-limited amplifier that is configured to amplify the frequency-multiplexed readout signal RO (in the millikelvin regime) with minimal added noise to thereby enhance the signal quality (e.g., improve the signal-to-noise ratio) of the frequency-multiplexed readout signal RO to enable a more accurate qubit-state discrimination. The HEMT amplifier 136 comprises a low-noise amplifier (LNA) that is further utilized to amplify the frequency-multiplexed readout signal RO at, e.g., 4K.

The amplified frequency-multiplexed readout signal RO applied to the second high-bandwidth transmission line 138, wherein the amplified frequency-multiplexed readout signal RO is transmitted from the cryogenic cooling chamber to a remaining portion of the readout signal path (or readout channel) comprising room temperature electronics which include, e.g., the amplifier 140, the anti-aliasing filter 150, the ADC circuitry 160, and the discriminator 170. The amplifier 140 is configured to filter the frequency-multiplexed readout signal RO (before sampling by the ADC circuitry 160) to restrict a bandwidth of the frequency-multiplexed readout signal RO to comply with the Nyquist-Shannon sampling theorem over a band of interest.

The ADC circuitry 160 is configured to sample the frequency-multiplexed readout signal RO to generate a digital representation of the frequency-multiplexed readout signal RO, and latch the sampled frequency-multiplexed readout signal RO into memory. The sampled frequency-multiplexed readout signal RO comprises a digital representation of the superimposed readout signals RO₁, . . . , RO_{N} for a given period of time and, therefore, comprises digital information that is indicative of the readout quantum states of the group of N superconducting qubits 122. In an exemplary embodiment, the ADC circuitry 160 is configured “under-sample” (sampling rate lower than the Nyquist rate) the frequency-multiplexed readout signal RO based on the Nyquist-Shannon sampling theorem in which the analog frequency-multiplexed readout signal RO is sampled at 2X the desired bandwidth.

For example, assuming that the filtered analog frequency-multiplexed readout signal RO comprises a combination of N readout signals RO₁, . . . , RO_{N} with respective center frequencies that are spread over a bandwidth of 750 MHZ, the ADC circuitry 160 can sample the filtered frequency-multiplexed readout signal RO at a sampling rate of 1.5 GHz to capture sampled data which is sufficient to discriminate the quantum states of the N superconducting qubits. In this regard, since the frequencies and duration of the measurement signal are fixed, under-sampling faithfully reconstructs the signals so long as the sampling bandwidth is greater than the signal bandwidth.

It is to be noted that FIG. 1 schematically illustrates an exemplary embodiment in which the anti-aliasing filter 150 and the under-sampling by the ADC circuitry 160 are used properly sample the analog frequency-multiplexed readout signal RO in conjunction with a direct RF generation system as discussed above. On the other hand, in other embodiments which implement a heterodyne system for I/Q modulation and mixing, the analog frequency-multiplexed readout signal RO can be frequency-downmodulated, digitized, and then discriminated. In particular, in instances where the multi-frequency RF readout control RF_RO comprises quadrature modulated RF readout control signals RF_RO₁, . . . , RF_RO_{N}, the in-phase (I) and quadrature (Q) analog components of the analog frequency-multiplexed readout signal RO would be extracted (demodulated) via analog I/Q mixing analog frequency-multiplexed readout signal RO with the same LO frequencies used for I/Q mixing and up-conversion. The extracted analog I and Q components of the analog frequency-multiplexed readout signal RO would then be sampled by separate ADCs to generate digital I and Q data that are indicative of the amplitudes and phases of the N readout signals RO₁-RO_{N} and, thus, indicative of the read-out quantum states of the N superconducting qubits.

The discriminator 170 is configured to analyze the digitized frequency-multiplexed readout signal RO using the trained kernels 172 to determine the quantum states of the superconducting qubits within the group of N frequency-multiplexed qubits. In an exemplary embodiment, the trained kernels 172 comprise at least one trained kernel per superconducting qubit. For example, in the exemplary embodiment of FIG. 1, the trained kernels 172 comprise at least N trained kernels for the group of N frequency-multiplexed qubits, with each of the N trained kernels associated with a corresponding one of the qubits within the group of N frequency-multiplexed qubits. Essentially, each kernel (or filter kernel) is a digital filter which comprises a sequence of values (e.g., x number of values) that represent a trained waveform pattern that is utilized to discern a given readout signal ROᵢ from the digitized frequency-multiplexed readout signal RO (superimposed signal which comprises the N readout signals RO₁-RO_{N}. In particular, each trained kernel comprises a sequence of values that essentially represent a sinusoidal waveform in the time domain (or an impulse waveform in the frequency domain) for a given readout frequency of a given readout resonator for a given qubit.

In some embodiments, the discriminator 170 is configured to analyze the digitized frequency-multiplexed readout signal RO by (i) computing a “dot product” (or scalar product) of the digitized frequency-multiplexed readout signal RO with each of the trained kernels 172 (e.g., perform N dot product computations in parallel) to obtain a scalar value for each dot product computation, and (ii) comparing the scalar values to a corresponding threshold values associated with the trained kernels 172 to discriminate between a measured |0 [symbol] state and a measured |1 [symbol] state of the qubits. In some embodiments, to implement the dot product computations, the digitized frequency-multiplexed readout signal RO and the trained kernels 172 comprise respective patterns with the same pattern length (e.g., x number of values). Indeed, as is known in the art, a dot product or scalar product is an algebraic operation that takes two equal-length sequences of numbers, and returns a single scalar value. For example, assuming x=1000, the digitized frequency-multiplexed readout signal RO and the trained kernels 172 would each comprise a respective pattern with different values, but with the same pattern length of 1000.

A dot product computation of a trained kernel and digitized frequency-multiplexed readout signal involves adding the sum of the products of corresponding entries of the two sequences of numbers representing the trained kernel and digitized frequency-multiplexed readout signal. For example, assume that a trained kernel K comprises a sequence of x values and is represented as: K=[k₁, k₂, . . . , kₓ], and that a given digitized frequency-multiplexed readout signal RO is represented as: RO=[r₁, r₂, . . . , rₓ]. In this instance, the dot product of K and RO may be computed as:

$$K \cdot RO = {\sum }_{i = 1}^{x} {k}_{i} {r}_{i} = {k}_{1} {r}_{1} + {k}_{2} {r}_{2} + … + {k}_{x} {r}_{x} .$$

In some embodiments, the discriminator 170 can be a hardware-based discriminator that is implemented in hardware with integrated circuitry that is configured to discriminate binary-outcome measurements in the computational basis, e.g., discriminate between measured |0 [symbol] and |1 [symbol] states. In other embodiments, the discriminator 170 can be a software-based discriminator that is implemented in software that is executed by one or more processors (e.g., FPGA, ASIC, etc.) to discriminate between measured |0 [symbol] and |1 [symbol] states. In other embodiments, the discriminator 170 can be implemented using a combination of hardware and software.

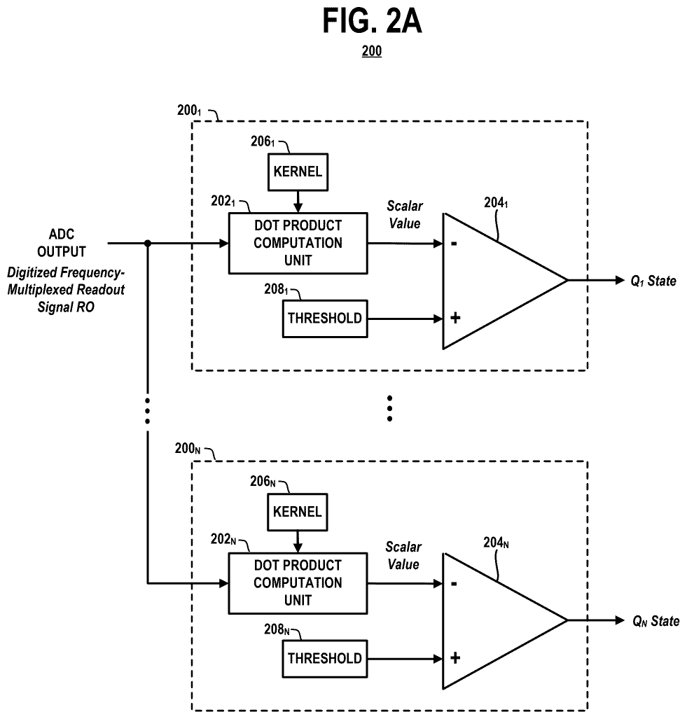

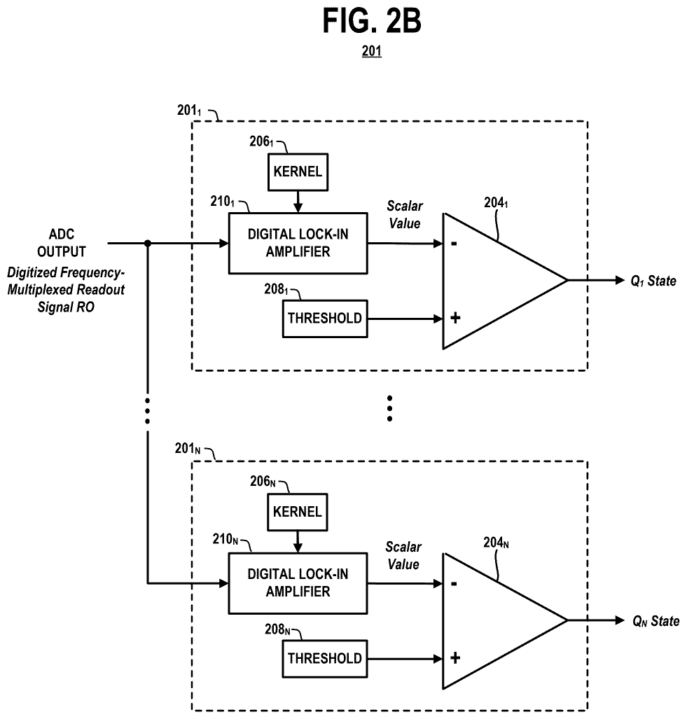

For example, FIG. 2A schematically illustrates a hardware discriminator which is configured to utilize trained kernels to analyze a frequency-multiplexed readout signal to discriminate quantum states of qubits, according to an exemplary embodiment of the disclosure. In particular, FIG. 2A schematically illustrates hardware discriminator 200 which comprises a plurality (N) of discriminator hardware modules 200₁, . . . , 200_{N}, which are configured to operate in parallel to analyze a digitized frequency-multiplexed readout signal RO for a group of N frequency-multiplexed qubits Q₁, . . . , Q_{N}, which is generated and output from ADC circuitry, to determine the quantum states of the qubits Q₁, . . . , Q_{N}. The discriminator hardware modules 200₁, . . . , 200_{N} each comprise a respective dot product computation unit 202₁, . . . , 202_{N}, and a respective comparator 204₁, . . . , 204_{N}. The dot product computation units 202₁, . . . , 202_{N} can be implemented using any dot product computation engine or logic circuit that is suitable for the given application.

As schematically illustrated in FIG. 2A, the discriminator hardware module 200₁ utilizes a trained kernel 206₁ and associated threshold 208₁ to discern/extract a corresponding readout signal RO₁ signal (e.g., determine the amplitude and phase of the readout signal RO₁ signal) in the digitized frequency-multiplexed readout signal RO, and to determine a state of the qubit Q₁ based on the determined phase and amplitude of the discerned/extracted readout signal RO₁ signal. In particular, the dot product computation unit 202₁ is configured to perform a dot product computation of the trained kernel 206₁ and the digitized frequency-multiplexed readout signal RO, and output a scalar value (at a given voltage level) which represents and amplitude and phase of the readout signal RO₁ signal. The comparator 204₁ is configured to compare the determined scalar value with the threshold 208₁ to discriminate between |0 [symbol] and |1 [symbol] quantum states of the qubit Q₁, based on the result of the comparison. In some embodiments, the threshold 208₁ can be a threshold voltage which is compared with the voltage level corresponding to the determined scalar value output, wherein the qubit Q₁ will be deemed to have (i) a |0 [symbol] state when the determined scalar value is greater than the threshold 208₁, or (ii) a |1 [symbol] state when the determined scalar value is less than the threshold 208₁.

Similarly, the discriminator hardware module 200_{N} utilizes a trained kernel 206_{N} and associated threshold 208_{N} to discern/extract a corresponding readout signal RO_{N} signal (e.g., determine the amplitude and phase of the readout signal RO_{N} signal) in the digitized frequency-multiplexed readout signal RO, and to determine a state of the qubit Q_{N} based on the determined phase and amplitude of the discerned/extracted readout signal RO_{N} signal. In particular, the dot product computation unit 202_{N} is configured to perform a dot product computation of the trained kernel 206_{N} and the digitized frequency-multiplexed readout signal RO, and output a scalar value (at a given voltage level) which represents and amplitude and phase of the readout signal RO_{N} signal. The comparator 204_{N} is configured to compare the determined scalar value with the threshold 208_{N} to discriminate between |0 [symbol] and |1 [symbol] quantum states of the qubit Q_{N}, based on the result of the comparison. In some embodiments, the threshold 208_{N} can be a threshold voltage which is compared with the voltage level corresponding to the determined scalar value output, wherein the qubit Q_{N} will be deemed to have (i) a |0 [symbol] state when the determined scalar value is greater than the threshold 208_{N}, or (ii) a |1 [symbol] state when the determined scalar value is less than the threshold 208_{N}.

It is to be understood that FIG. 2A illustrates a non-limiting exemplary embodiment of implementing the discriminator hardware modules 200₁, . . . , 200_{N} using dot product computation units. However, in other embodiments, the discriminator hardware modules 200₁, . . . , 200_{N} can implement digital lock-in amplifiers (instead of the dot product computation units) to discern/extract corresponding readout signals RO₁, . . . , RO_{N} in the digitized frequency-multiplexed readout signal RO. For example, FIG. 2B schematically illustrates a hardware discriminator 201 which is configured to utilize trained kernels to analyze a frequency-multiplexed readout signal to discriminate quantum states of qubits, according to another exemplary embodiment of the disclosure. The hardware discriminator 201 comprises a plurality (N) of discriminator hardware modules 201₁, . . . , 201_{N}, which are similar to the discriminator hardware modules 200₁, . . . , 200_{N} in FIG. 2A, except that discriminator hardware modules 201₁, . . . , 201_{N} implement digital lock-in amplifiers 2101, . . . , 210N instead of dot product computation units.

The digital lock-in amplifiers 2101, . . . , 210N can be implemented using FPGA devices and digital signal processing techniques, which are configured to measure the presence of corresponding readout signals RO₁, . . . , RO_{N} in the digitized frequency-multiplexed readout signal RO. In general, a given digital lock-in amplifier can be configured to extract phase and amplitude information of a given readout signal ROᵢ in the digitized frequency-multiplexed readout signal RO, and output a scalar value (e.g., a DC voltage) which represents the extracted information of the given readout signal ROᵢ in the digitized frequency-multiplexed readout signal RO.

In general, a lock-in amplifier operates by (i) multiplying the digitized frequency-multiplexed readout signal RO by a digital reference signal represented by the trained kernel, (ii) integrating the multiplication product over a specified period of time to, e.g., reduce noise and enhance the given readout signal ROᵢ, and (iii) outputting a scalar value (e.g., DC signal) that represents the given readout signal ROᵢ. The lock-in amplifier is highly selective to the target readout signal ROᵢ component in the digitized frequency-multiplexed readout signal RO, where the gain of the lock-in amplifier tends to drop to zero within a few Hertz outside the frequency bandwidth of the target readout signal ROᵢ in the digitized frequency-multiplexed readout signal RO. In this regard, the contribution from any RO signal component that is not at the same frequency as the reference signal (represented by the kernel) is attenuated close to zero.

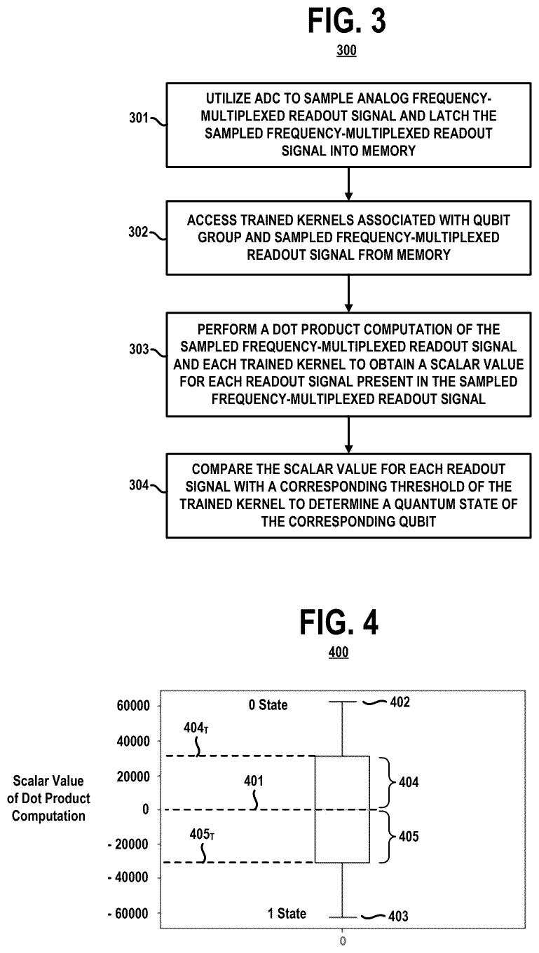

In other embodiments, as noted above, the discriminator 170 in FIG. 1 can be a software-based discriminator that is implemented in software that is executed by one or more processors (e.g., FPGA, ASIC, etc.) to discriminate between measured |0 [symbol] and |1 [symbol] states. For example, FIG. 3 is a flow diagram which illustrates a method 300 for utilizing trained kernels to analyze a frequency-multiplexed readout signal to discriminate quantum states of qubits, according to an exemplary embodiment of the disclosure, wherein the method 300 can be implemented in software with program instructions that are executed by one or more processors. The method 300 is configured to perform software-based dot product computations in parallel to extract information from a frequency-multiplexed readout signal to discriminate the quantum states of a group of N qubits.

An initial step of the method 300 includes utilizing ADC circuitry to sample (e.g., under-sample) an analog frequency-multiplexed readout signal RO to generate a digitized frequency-multiplexed readout signal RO, and latch the sampled (digitized) frequency-multiplexed readout signal RO into memory (block 301). For purposes of discussion, it is assumed that the sampled (digitized) frequency-multiplexed readout signal RO comprises a combination of N readout signals RO₁, . . . , RO_{N} which represent respective quantum states of N qubits in the qubit group. With this sampling process, as noted above, the digitized frequency-multiplexed readout signal RO is represented by a sequence of x values, where each value is stored in a given memory location in the memory.

Next, the method 300 accesses from memory, N trained kernels associated with the N qubits within the qubit group, as well as the sampled (digitized) frequency-multiplexed readout signal RO (block 302), and performs, in parallel, N dot product computations to compute a dot product of the sampled (digitized) frequency-multiplexed readout signal RO and each of the N trained kernels to thereby obtain a scalar value for each of the N readout signal RO₁, . . . , RO_{N} present in the sampled (digitized) frequency-multiplexed readout signal RO (block 303). As noted above, the dot product of the sampled (digitized) frequency-multiplexed readout signal RO and a given trained kernel (which is associated with a given qubit) essentially reduces the corresponding readout signal ROᵢ to a single scalar value that is used for discrimination. In particular, the method 300 compares the resulting scalar value of each of the N readout signal RO₁, . . . , RO_{N} with a corresponding threshold of the associated training kernel to determine a quantum state of the corresponding qubit (block 304).

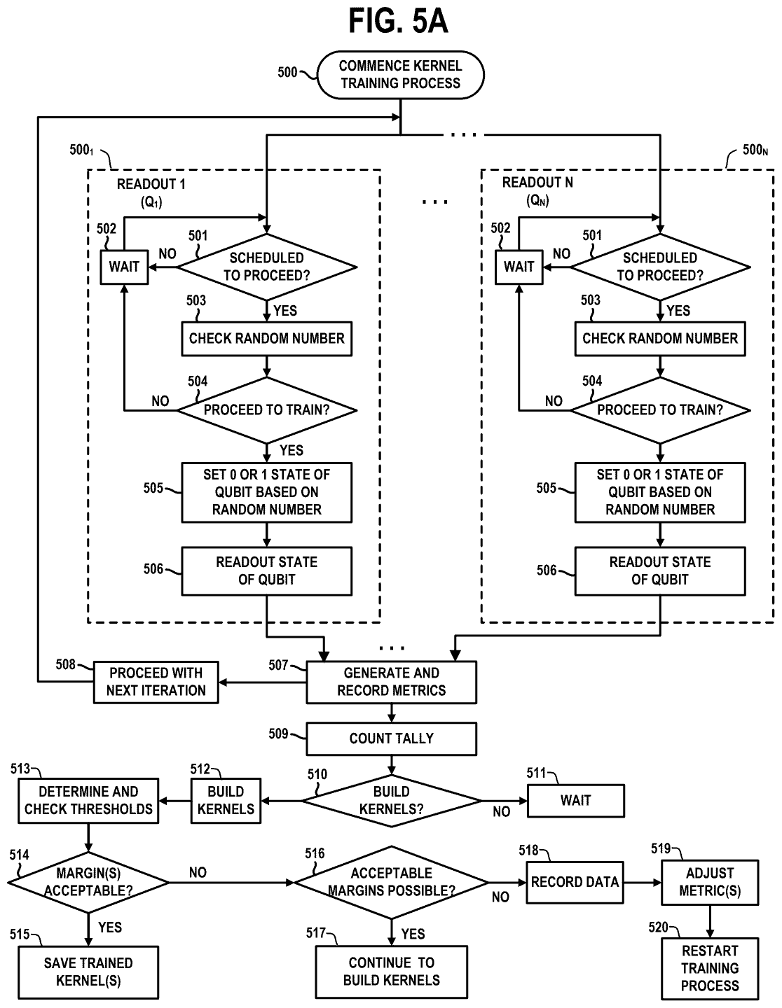

FIG. 4 schematically illustrates a method to discriminate quantum states of a given qubit, according to an exemplary embodiment of the disclosure. More specifically, FIG. 4 schematically illustrates a method 400 for utilizing a scalar value, which is obtained by computing a dot product of digitized frequency-multiplexed readout signal RO and a trained kernel, to discriminate a quantum state of a given qubit that is associated with the trained kernel. As shown in FIG. 4, a vertical axis represents a range of scalar values that can result from performing dot product computations using the trained kernel, wherein the scalar values span from 60K to-60K. In addition, FIG. 4 shows a threshold value 401 that is associated with the trained kernel, an upper threshold value 402 (e.g., scalar value of 60K) for discriminating a |0 [symbol] state, and a lower threshold value 403 (e.g., −60K) for discriminating a |1 [symbol] state.

The range of scalar values from 60K to −60K represents an ideal or target resolution of scalar values for discriminating between the computational basis states of |0 [symbol] and |1 [symbol] of a given qubit. However, FIG. 4 shows resolutions of scalar values 404 and 405 that are actually realized for discriminating the computational basis states of |0 [symbol] and |1 [symbol] , respectively, of the given qubit, wherein the scalar values 404 and 405 span over a resolution range from a threshold value 404T of about 30K to a threshold value 405T of about −30K. In addition, FIG. 4 shows an exemplary embodiment in which the threshold value 401 associated with the trained kernel corresponds to a scalar value of zero (0) to distinguish between a |0 [symbol] state and a |1 [symbol] state. In particular, For example, FIG. 4 shows an exemplary embodiment in which the given qubit will be deemed to have (i) a quantum state of |0 [symbol] when the scalar value resulting from a dot product between the trained kernel and the digitized frequency-multiplexed readout signal is greater than the threshold value 401 (e.g., a positive scalar value greater than zero), or (i) a quantum state of |1 [symbol] when the scalar value resulting from a dot product between the trained kernel and the digitized frequency-multiplexed readout signal is less than the threshold value 401 (e.g., a negative scalar value less than zero). For the exemplary hardware discriminator embodiments shown in FIGS. 2A and 2B, the threshold value 401 associated with a trained kernel can correspond to given threshold voltage level that is used for the comparison operation.

While a trained kernel is very good at matching the same frequency content of a time domain waveform, in a frequency-multiplexed qubit readout system in which the frequency-multiplexed readout signals from multiple readout resonators of multiple qubit share a single readout bus and readout amplifier chain, any crosstalk and noise from the other qubits can result in signal distortions which render a trained kernel less accurate in extracting relevant information (e.g., amplitude and phase) at the given frequency of the target readout signal, leading to degraded readout fidelity. Indeed, a frequency-multiplexed readout signal (which contains state information of multiple qubits) is susceptible to crosstalk-induced qubit-state-readout errors. Such crosstalk errors can result from, e.g., interactions between the qubits within the qubit group, qubits parasitically coupling to readout resonators associated with other qubits, insufficient spectral separation between readout resonator frequencies, and other interactions which can degrade readout fidelity and therefore render state discrimination more challenging.

With regard to kernel training, a common practice is to train one kernel at a time. However, for a quantum system with a relatively large number of qubits, this training process is impractical because it requires a large number of single (non-parallel) kernel training iterations per qubit, e.g., 10K training iterations per qubit. In this regard, with a frequency-multiplexed qubit readout system which implements a N:1 multiplexed readout, the number of single kernel training iterations for the given multiplexed group of N qubits would be N×10K, e.g., 100K iterations when N=10. Moreover, the training of one kernel per qubit at a time does not take into consideration the individual contribution of each of the readout signals against each other in a frequency-multiplexed readout signal. Thus, if each kernel per qubit is trained separately, the kernel for a given qubit may be less effective in discerning/extracting the corresponding qubit readout signal from the frequency-multiplexed readout signal when the extracted readout signal for the given qubit comprises remnants of other qubit readout signals of other qubits within the multiplexed group of N qubits.

As noted above, exemplary embodiments of the disclosure implement kernel training techniques in which multiple kernels are trained in parallel. For example, with a frequency-multiplexed readout system, the kernels for a multiplexed group of N qubits are trained in parallel using information derived from frequency-multiplexed readout signals which include readout signals of the N qubits, in a randomized manner. The parallel kernel training process allows each kernel for each qubit to be constructed in way that takes into consideration the individual contributions and interactions (e.g. cross-talk) of other readout signals of other qubits in the multiplexed group of N qubits, thereby rendering each kernel for each qubit to be effective in discerning/extracting corresponding qubit readout signals from the frequency-multiplexed readout signal. In addition, the parallel kernel training process allows the kernels of the qubits to be effectively built using significantly less training iterations, as compared to a process of training one kernel per qubit at a time.

In some embodiments, an exemplary process for training the kernels of a multiplexed group of N qubits comprises (i) performing multiple single kernel training iterations to obtain training data for each kernel of each qubit alone, (ii) performing multiple parallel kernel training iterations to obtain training data for multiple kernels of multiple qubits in parallel, in a randomized manner, and (iii) utilizing the training data obtained from the single kernel training iterations and the parallel kernel training iterations to build the kernels for each qubit in the multiplexed group of N qubits. In particular, the single kernel training iterations involve obtaining kernel training data for each qubit alone, e.g., kernel training data is acquired for a given Qᵢ alone (no multiplexed-frequency readout) with the given the given Qᵢ set to a |0 [symbol] state for a programmable number of iterations, and the given Qᵢ set to a |1 [symbol] state for a programmable number of iterations. On the other hand, the parallel kernel training iterations involve obtaining training data for multiple kernels of multiple qubits in parallel in a randomized manner (e.g., via a pseudo random generator) where for each iteration, kernel training data is obtained with each qubit within the group of N qubits having one of random states including a |0 [symbol] state, a |1 [symbol] state, or a X state over a programmable number of iterations, wherein the X state means that the given qubit is not active for the given kernel training iteration (e.g., the state of the qubit is not set and readout for the given iteration).

In some embodiments, the single kernel training iterations are optional such that a kernel training process can be implemented by performing a programmable number of parallel kernel training iterations, without performing single kernel training iterations, wherein the kernel training data acquired from the parallel kernel training iterations is utilized to build the kernels for each qubit in the multiplexed group of N qubits. However, it is to be appreciated that the kernel training data acquired using single kernel training iterations can provide a corrective measure in instances where the randomization of the qubit states utilized to implement the parallel kernel training iterations may be problematic in achieving good results. Indeed, there can be instances where certain qubits randomly align themselves too closely to each other, which makes it hard to distinguish them and acquire sufficient kernel training data using parallel kernel training iterations alone. In such instance, the kernel building process can be configured to utilize the training data obtained from both single kernel training iterations and parallel kernel training iterations to build the kernels for each qubit in a multiplexed group of N qubits.

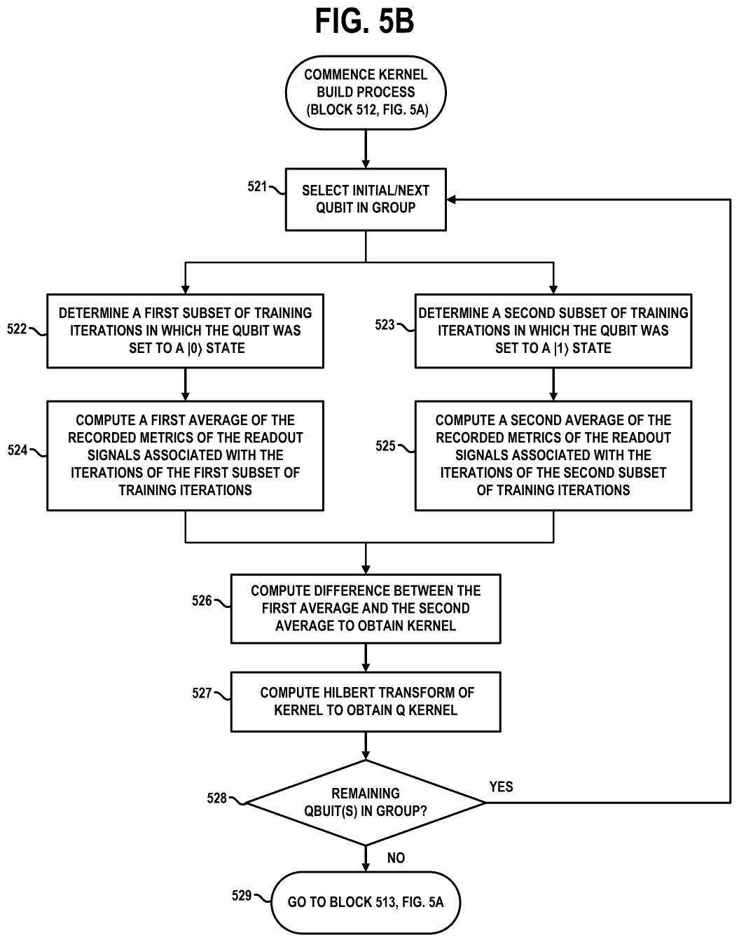

FIGS. 5A and 5B are flow diagrams which illustrate a method for training a group of kernels that are configured to analyze frequency-multiplexed readout signals for a group of qubits to discriminate quantum states of the group of qubits, according to an exemplary embodiment of the disclosure. In some embodiments, FIGS. 5A and 5B illustrate an exemplary process for training the kernels of a multiplexed group of N qubits which, as discussed above, comprises performing multiple single kernel training iterations to obtain training data for each kernel of each qubit alone, performing multiple parallel kernel training iterations to obtain training data for multiple kernels of multiple qubits in parallel, in a randomized manner, and utilizing the training data obtained from the single kernel training iterations and the parallel kernel training iterations to build the kernels for each qubit in the multiplexed group of N qubits. In addition, as explained in further detail below, FIGS. 5A and 5B illustrate exemplary process steps that can be utilized to perform multiple single kernel training iterations to obtain training data for each kernel alone, wherein the single kernel training iterations are performed by skipping certain steps in the process flow of, e.g., FIG. 5A.

It is to be noted that in some embodiments, FIGS. 5A and 5B depict an exemplary kernel training process which can be implemented in software (e.g., Matlab, Python, etc.) and executed on, e.g., a personal computer, to perform a simulated kernel training process to obtain a kernel training sequence that can be utilized to configure the parameters of a hardware kernel training process that is performed on a given quantum computing system. Moreover, in other embodiments, FIGS. 5A and 5B depict an exemplary kernel training process which can be executed by a quantum computing system to train kernels for frequency-multiplexed readout of actual qubits using actual hardware of a frequency-multiplexed readout system of the quantum computing system. In this regard, certain steps in the process flow of FIGS. 5A and 5B can be performed in different manners, depending on whether the process is (i) a computer simulated kernel training process implemented in software and executed on a computer, or (ii) a kernel training process that is implemented by a quantum control system operating on actually quantum computing hardware (e.g., physical qubits and frequency-multiplexed readout control circuitry to readout quantum states of the physical qubits, etc.).

Referring to FIG. 5A, a kernel training process is commenced (block 500). In some embodiments, the kernel training process is commenced by a user launching a computer simulated kernel training process on a personal computer. In other embodiments, the kernel training process is commenced by a control process executing on a quantum computing system. The kernel training process comprises a plurality (N) of readout control processes 500₁, . . . , 500_{N} that are configured to operate in parallel in a synchronized manner in which execution of training operations by the readout control processes 500₁, . . . , 500_{N} are synchronized based on a training schedule. For each iteration of the kernel training process, each readout control process 500₁, . . . , 500_{N} is configured to set a state of a corresponding one of N qubits Q₁, . . . , Q_{N}, and initiate readout of the corresponding qubit, according to training schedule. In some embodiments, the kernel training process is configured to perform a programmable number of training iterations Tᵢ, e.g., i=10K, i=15K, etc. In some embodiments, a portion of the total number of iterations i of the kernel training process can be single kernel training iterations, while a remaining portion of the total number of iterations of the kernel training process can be parallel kernel training iterations.

More specifically, as schematically illustrated in FIG. 5A, each readout control process 500₁, . . . , 500_{N} performs a same process flow. For example, each readout control process 500₁, . . . , 500_{N} utilizes a training schedule to determine when the readout control process is scheduled to proceed with a given training iteration (block 501). In some embodiments, the readout control processes 500₁, . . . , 500_{N} are synchronized using synchronous time of day (TOD) counters for scheduling the commencement of training operations. For example, each readout control process 500₁, . . . , 500_{N} utilizes a respective TOD counter and associated timing/scheduling information within an instruction stream to synchronize the execution of the process steps execution across the readout control processes 500₁, . . . , 500_{N} at program start and branch points.

For example, in the context of performing parallel kernel training iterations of the kernel training process, the commencement of a given parallel training iteration is time synchronized across the readout control processes 500₁, . . . , 500_{N} based on the given training schedule. If a given readout control process is not scheduled to commence a training iteration operation at a given time (negative determination in block 501), the readout control process will remain in a wait state (block 502) until the readout control process is scheduled to proceed with a training iteration. When the readout control process determines that it is scheduled to proceed with a training iteration (affirmative determination in block 501), the readout control process will perform a random number check operation (block 503). In particular, in the context of performing parallel kernel training iterations of the kernel training process, the kernel training process utilizes or otherwise implements a random number generator module that is configured to generate random numbers that specify, for a given training iteration, which of the N qubits should be active (e.g. readout state) for the given kernel training iteration, and for each active qubit, which state (e.g., either |0 [symbol] state or |1 [symbol] ) to set the qubit for the given kernel training iteration.

In response to the commencement of a given parallel kernel training iteration, each readout control process 500₁, . . . , 500_{N} will perform the random number check operation (block 503) to determine whether or not the corresponding qubit Q₁, . . . , Q_{N} should be active for the given kernel training iteration (block 504). If a given readout control process determines, based on the random number check, that the corresponding qubit should not be active for the given kernel training iteration (negative determination in block 504), the readout control process will remain in a wait state (block 502) until the readout control process is scheduled to proceed with a next training iteration. On the other hand, if the given readout control process determines, based on the random number check, that the corresponding qubit should be active for the given kernel training iteration (affirmative determination in block 504), the readout control process will proceed to determine, based on the random number check, whether the corresponding qubit should be set to a |0 [symbol] state or a |1 [symbol] , and then proceed to set the quantum state of the corresponding qubit according to the randomly specified state |0 [symbol] or |1 [symbol] (block 505).

At the completion of each qubit state setting process (block 505) at least a subset of the qubits within the group of N qubits Q₁, . . . , Q_{N} will have quantum states that are randomly set to either a |0 [symbol] state or a |1 [symbol] state, while the remaining qubits will be inactive, as indicated by states denoted by X. For example, assuming N=10, the group of ten (10) qubits Q₁, Q₂, Q₃, Q₄, Q₅, Q₆, Q₇, Q₈, Q₉, and Q₁₀ may have the respective states X, 1, 1, 1, X, X, 0, 1, 0, X, where qubits Q₁, Q₅, Q₆ and Quo are not active for the given parallel training iteration. In some instances, all qubits within the group of N qubits Q₁, . . . , Q_{N} will have quantum states that are randomly set to a |0 [symbol] state or a |1 [symbol] state, for the given parallel training iteration.

It is to be appreciated that the exemplary process flow of blocks 503, 504, and 505 essentially implement a double pseudo random number check via a layer of two random operations that are performed for each parallel training iteration. In particular, in each parallel training iteration, a first random operation is performed to randomly determine whether a given qubit (in the group of N qubits) will be active or inactive for the given parallel training iteration, and a second random operation is performed to randomly determine whether the state of a given qubit (which is randomly selected to be active for the given iteration) should be set to a |0 [symbol] state or a |1 [symbol] state for the given parallel training iteration. The layering of the two random operations adds additional randomness in the training process which allows the acquired training data to be statistically balanced. Moreover, the multi-layer randomization in conjunction with the parallel kernel training process enables a significant reduction in the number of kernel training iterations needed to effectively train a plurality of kernels, as compared to the number of iterations that would be needed for single kernel training iterations.

It is to be noted that the two random number generation operations can be implemented using various techniques. For example, in some embodiments, the two random number generation operations are performed using pseudo-random number generation techniques. For example, a pseudorandom number generator (PRNG) algorithm is configured to generate a sequence of numbers based on a seed value. In other embodiments, the two random number generation operations can be performed using true random number generator (TRNG) techniques. For example, a true random number generator can be performed by a quantum system using qubits to perform a “quantum coin toss.” In particular, a plurality of qubits can each be initialized into a given state, e.g., |0 [symbol] state. A Hadamard gate operation is then applied to each qubit to change the initial state of each qubit into a superposition of both states |0 [symbol] and |1 [symbol] , i.e., a superposed state

$$\vert ψ 〉 = \frac{1}{\sqrt{2}} \vert 0 〉 + \frac{1}{\sqrt{2}} \vert 1 〉 .$$

The superposed state of each qubit is then measured in which case the measured state of each qubit will be either a |0 [symbol] or |1 [symbol] , with equal probability, resulting in a true random bit.

Referring back to FIG. 5A, following the completion the qubit state setting processes (block 505), each readout control process 500₁, . . . , 500_{N} with an active qubit (for the given parallel training iteration) will proceed to readout the state of the corresponding qubit (block 506). For a computer simulated kernel training process, the kernel training process will essentially combine and superimpose all analog readout signals from the active qubits into single analog readout signal, to simulate all readout signals of all active qubits for the given parallel training iteration being readout on a shared readout bus. In this regard, the computer simulated kernel training process is configured to implement a simulated model of an analog frequency-multiplexed readout signal which represents the individual contributions of the readout signals and the interactions (e.g., simulate cross-talk) between the readout signals of the active qubits. On the other hand, for a hardware kernel training process, the states of the active qubit can be read out onto a shared readout but using techniques as discussed above in conjunction with the exemplary frequency-multiplexed readout system 100 of FIG. 1, the details of which will not be repeated.

Next, the kernel training process proceeds to generate and record metrics which represent the analog frequency-multiplexed readout signal that is readout for the given kernel training iteration (block 507). The metrics that are generated and recorded comprise training data that is utilized to build the kernels. In some embodiments, the process of generating metrics comprises performing an ADC process to sample (e.g., under-sample) the analog frequency-multiplexed readout signal. For example, with a computer simulated kernel training process implemented in, e.g., Matlab, an ADC process can be simulated in software. In other embodiments, other signal processing techniques, such as filtering, which are typically performed on analog frequency-multiplexed readout signals, can be utilized to generate and record desired metrics for use in training kernels.

After the metrics generated and recorded, the kernel training process will proceed with the next iteration (block 508), assuming that there is at least one remaining iteration of the total number of iterations i of the kernel training process which is to be performed. In addition, the kernel training process proceeds to update a count tally associated with all previous iterations of the kernel training process (block 509). For example, a count tally process will count and keep track of (i) the number of times that each qubit Q₁-Q_{N} was activated over the previous iterations, and (ii) the initialized state of each activated qubit Q₁-Q_{N} in each previous iteration. For example, assume that the first qubit Q₁ had the following states for the initial fifteen (15) iterations: (X, 1, 1, X, 0, 1, X, X, 0, 0, 1, X, 1, 0, 0). In this case, after the 15th iteration of the kernel training process, the count tally for the first qubit Q₁ will indicate that that the first qubit Q₁ was activated ten (10) times-five times with an initialized |0 [symbol] state (in the 5^{th}, 9^{th}, 10^{th}, 14^{th}, and 15^{th} iterations), and five times with an initialized |1 [symbol] state (in the 2^{nd}, 3^{rd}, 6^{th}, 11^{th}, and 13^{th} iterations). It is to be noted that is a simplified example for illustrative purposes. Indeed, in some embodiments, the initial set of iterations of the kernel training process may comprise single kernel training iterations, in which case the first 100 iterations, for example, may comprises single kernel training iterations in which, e.g., the first qubit Q₁ was initialized to a |0 [symbol] state for each iteration, while all other qubits Q₂-Q₁₀ were not active.

It is to be noted that the above example assumes that the initial set of training iterations include parallel kernel training iterations. However, in some embodiments, the initial set of kernel training iterations may comprise single (non-parallel) kernel training iterations that are performed for each qubit, wherein kernel training data is acquired for a given Qᵢ alone (no multiplexed-frequency readout) with the given the given Qᵢ set to a |0 [symbol] state for a programmable number of iterations, and the given Qᵢ set to a |1 [symbol] state for a programmable number of iterations. In this regard, in some embodiments, the kernel training process of FIG. 5A may initially be configured to perform single (non-parallel) kernel training iterations for each qubit Q₁, . . . , Q_{N} by running each readout control process 500₁, . . . , 500_{N} separately for each respective qubit Q₁, . . . , Q_{N}. For example, the readout control process 500₁ can be utilized to perform single (non-parallel) kernel training iterations for the qubit Q₁. In this instance, the readout control process 500₁ determines (in block 501) whether a single kernel training iteration is scheduled for the qubit Q₁. If so, the readout control process 500₁ will proceed to determine (in block 505) whether to set the qubit Q₁ to a |0 [symbol] state or a |1 [symbol] state. For single kernel training iterations, the number of single kernel training iterations to acquire kernel training data for the |0 [symbol] state and the |1 [symbol] state for a given qubit Qᵢ are prespecified, and thus, the random number generation and check operations in blocks 503, 504, and 505 for the parallel kernel training iterations are not utilized for single kernel training iterations. For the single kernel training iterations, the kernel training process proceeds to generate and record metrics (in block 507) which represent the analog readout signal that is readout for a single qubit for the given single kernel training iteration.

At some point in the kernel training process, a kernel build process is commenced to start building the kernels for the qubits Q₁-Q₁₀ using the recorded metrics. For example, in some embodiments, a kernel build process can commence after a prespecified number of iterations of the kernel training process have been completed (e.g., 10%, 20%, etc., of the total number of iterations). In some embodiments, a kernel build process can be commenced after completing the first iteration or the first few iterations of the kernel training process. In some embodiments, a kernel build process can be commenced after completing all prespecified iterations of the kernel training process.

In this regard, after the completion of a given iteration, the kernel training process will determine whether to start (or continue) a kernel building process (block 510). If the kernel training process determines not to commence (or continue) a kernel building process (negative determination in block 510), the kernel training process will wait (block 511) to commence or continue the kernel building process until the occurrence of a given event which triggers the commencement (or continuance) of the kernel building process. On the other hand, if the kernel training process determines to commence (or continue) the kernel building process (affirmative determination in block 510), the kernel building process will proceed to build (or update) kernels (block 512).

The kernels for the group of N qubits Q₁-Q_{N} can be built using various techniques. For example, FIG. 5B illustrates a method which can implemented in block 512 of FIG. 5A to build a kernel for each qubit Qᵢ (i=1, . . . , N) of the group of N qubits Q₁-Q_{N}, according to an exemplary embodiment of the disclosure. When the kernel build process is commenced (block 512 of FIG. 5A), a given qubit Qᵢ is selected for processing (block 521). The kernel build process proceeds to (i) determine a first subset of training iterations in which the given qubit Qᵢ was set to a |0 [symbol] state (block 522), and (ii) determine a second subset of training iterations in which the given qubit Qᵢ was set to a |1 [symbol] state (block 523).

For purposes of illustration, assume that the kernel build process is commenced after performing 20 training iterations and that that the given qubit Qᵢ had the following states, respectively, for the 20 training iterations: (X, 1, 1, X, 0, 1, X, X, 0, 0, 1, X, 1, 0, 0, X, X, 1, X, 0). In this case, the first subset of training iterations (of the 20 iterations) in which the given qubit Qᵢ was set to a |0 [symbol] state would include the 5^{th}, 9^{th}, 10^{th}, 14^{th}, 15^{th} and 20^{th} training iterations (which includes a tally of 6 iterations the first set of training iterations). Furthermore, the second subset of training iterations (of the 20 iterations) in which the given qubit Qᵢ was set to a |1 [symbol] state would include the 2^{nd}, 3^{rd}, 6^{th}, 11^{th}, 13^{th}, and 18^{th} training iterations (which include a tally of 6 iterations the second set of training iterations).

It is to be noted that the above example assumes that the initial set of training iterations include parallel kernel training iterations. However, as noted above, in some embodiments, the initial set of kernel training iterations may comprise single (non-parallel) kernel training iterations that are performed for each qubit, wherein kernel training data is acquired for a given Qᵢ alone (no multiplexed-frequency readout) with the given the given Qᵢ set to a |0 [symbol] state for a programmable number of iterations, and the given Qᵢ set to a |1 [symbol] state for a programmable number of iterations. In this regard, in some embodiments, the kernel build process may be initially commenced at time when the kernel training data comprises only data obtained from single (non-parallel) kernel training iterations.

Next, the kernel build process proceeds to (i) compute a first average of a first set of recorded metrics of the readout signals associated with the training iterations of the first subset of training iterations (block 524), and (ii) compute a second average of a second set of recorded metrics of the readout signals associated with the training iterations of the second subset of training iterations (block 525). More specifically, the first average is computed by summing the metrics data (e.g., frequency-multiplexed readout signal data) in memory of all iterations in the first subset of training iterations for which the given qubit Qᵢ was set to a |0 [symbol] state, and dividing by the number (tally) of iterations in the first subset of training iterations. Similarly, the second average is computed by summing the metrics data (e.g., frequency-multiplexed readout signal data) in memory of all iterations in the second subset of training iterations for which the given qubit Qᵢ was set to a |1 [symbol] state, and dividing by the number (tally) of iterations in the second subset of training iterations.

Essentially, the computed first average provides an average of the set of frequency-multiplexed readout signals associated with the first subset of training iterations, which includes an average of the readout signal of the qubit Qᵢ when set in the |0 [symbol] state, taking into consideration contributions/components of the readout signals of other qubits in the frequency-multiplexed readout signals represented by the recorded metrics. Similarly, the computed second average provides an average of the set of frequency-multiplexed readout signals associated with the second subset of training iterations, which includes an average of the readout signal of the qubit Qᵢ when set in the |1 [symbol] state, taking into consideration contributions/components of the readout signals of other qubits in the frequency-multiplexed readout signals represented by the recorded metrics. In this instance, computing an average of the recorded readout signal data in memory for a number of iterations in which the given qubit Qᵢ has the same state serves to average away the contributions/components of the readout signals of the other qubits and, thus, reduce the effect of such other contribution/components of qubits for building a kernel that is configured to properly discriminate states of the given qubit Qᵢ in a frequency-multiplexed readout signal comprising readout signals of the other qubits.

A next step in the kernel build process comprises constructing a kernel for the given qubit Qᵢ using the computed average data. For example, in some embodiments, the kernel build process proceeds to compute a difference between the first average of the recorded metrics for the |0 [symbol] state and the second average of the recorded metrics for the (0) state to obtain a kernel for the qubit Qᵢ (block 526). More specifically, in some embodiments, the kernel is computed by computing a difference between the first average of the recorded metrics for the |0 [symbol] state and the second average of the recorded metrics for the (0) state to obtain an I kernel for the qubit Qᵢ. In some embodiments, one or more additional signal processing processes can be applied to construct the kernel. For instance, the computed kernel can be filtered to remove transient states. In addition, the computed kernel can be further sampled (e.g., under-sampled) as desired to extract more accurate data for constructing the kernel.

Furthermore, in some embodiments, an associated Q kernel is then determined by computing a Hilbert transform of the I kernel to obtain the Q kernel (block 527). In some embodiments, I and Q kernels are utilized to discriminate I and Q components of readout signals for frequency-multiplexed readout systems in which, e.g., I/Q modulation is implemented to demodulate and down-convert readout signals into constituent I and Q signals that are sampled and then discriminated. On the other hand, for the frequency-multiplexed readout system 100 in FIG. 1 which does not implement I/Q modulation is implemented to demodulate and down-convert readout signals into constituent I and Q signals, Q kernels are not needed to discriminate qubit states.

The kernel build process continues to build kernels for each quit in the group of N qubits. If there are any remaining qubits in the group of N qubits for which a kernel needs to be built (affirmative result in block 528), the kernel build process will select a next qubit in the group (block 521), and proceed to build the kernel(s) for the next qubit by repeating the process flow of blocks 522, 523, 524, 525, 526, and 527. If there are no remaining qubits in the group of N qubits for which a kernel needs to be built (negative determination in block 528), the process flow proceeds to block 513 of FIG. 5A (block 529).

Referring back to FIG. 5A, after building/updating a current set of kernels for the group of N qubits, the kernel training process proceeds to determine and check thresholds for the kernels to thereby determine if acceptable margins are obtained for the kernels to properly discriminate qubit states (block 513). For example, as discussed above in conjunction with FIG. 4, target threshold values (e.g., upper and lower threshold values 402 and 403) of dot product results that are achieved using a given kernel to discriminate the computational basis states |0 [symbol] and |1 [symbol] may include scalar values that span from 60K to-60K. On the other hand, for a given kernel, the actual resolution of scalar values (e.g., range of scalar values 404 and 405 with associated threshold values 404T and 405T) of dot product results that are obtained for discriminating the computational basis states |0 [symbol] and |1 [symbol] may span over a resolution range from about 30K to about-30K.

In this regard, in some embodiments, a threshold determination and check process (block 513) for a given kernel of a given qubit Qᵢ can be performed by computing dot products computations of the given kernel (e.g., the kernel that was recently computed in block 526, FIG. 5B for the given qubit Qᵢ) and the set of frequency-multiplexed readout signal data associated with the first subset of iterations and the second subset of iterations for the computational basis states of |0 [symbol] and |1 [symbol] , respectively, that were determined (e.g., in blocks 522 and 523) and utilized to build the kernel for a given qubit Qᵢ. The set of computed dot product results are then analyzed to determine the actual upper and lower resolution of scalar values (e.g., range of scalar values 404 and 405 with associated threshold values 404T and 405T) that are obtained as a result of performing the dot product computations using the given kernel of the given qubit Qᵢ.

The actual upper and lower resolution of scalar values of the dot product computations are then compared to the target threshold values to determine if an acceptable margin is obtained for the given kernel in discriminating the computational basis states of |0 [symbol] and |1 [symbol] of the given qubit Qᵢ (block 514). For example, in some embodiments, an acceptable margin is determined by computing a threshold ratio R of the actual threshold value obtained for a given computational basis state to the target threshold value for the given computational basis state,

$$R = \frac{actual threshod}{target threshold} ,$$

and comparing the given threshold ratio R to a specified margin threshold M. In some embodiments, a margin for a given kernel will be deemed acceptable (affirmative determination in block 514) when the given threshold ratio R is equal to or greater than the specified margin threshold M (e.g., R≥M). For example, in the exemplary embodiment shown in FIG. 4, assuming that the target upper threshold value 402 is 60K for discriminating the |0 [symbol] state, and that the actual threshold value 404T of 30K is obtained for discriminating the |0 [symbol] state, the threshold ratio would be computed as

$$R = \frac{30 K}{60 K} = 0.5 .$$

Assuming that the specified margin threshold M=0.50, then the determined threshold value of R=0.50 could be deemed acceptable.

It is to be noted that threshold check process (block 513) and the margin check process (block 514) are performed for each kernel that was recently constructed (block 512). For each kernel that is deemed to have an acceptable margin (affirmative determination in block 514) for discriminating the computational basis states of |0 [symbol] and |1 [symbol] of a respective qubit Qᵢ, the kernel training process can be deemed complete and the trained kernel for the respective qubit Qᵢ is persistently saved in memory (block 515). On the other hand, for each kernel that is deemed to not yet have an acceptable margin (negative determination in block 514), a determination is made as to whether acceptable margins are possible for such kernels by continuing the given kernel training process (block 516).

For example, in circumstances where the kernel build process (block 512) is performed at some point during the kernel training process before the specified number of iterations of the kernel training process have been completed (e.g., where kernels are built after each training iteration, or after a certain amount of training iteration have been performed, etc.), a determination can be made as to whether or not acceptable margins can be achieved for the remaining kernels (having currently unacceptable margins) by continuing with more of the remaining training iterations of the given kernel training process based on the same metrics/parameters as specified at the outset for the given kernel training process (block 516). If the kernel training process determines that acceptable margins can be achieved for the remaining kernels (affirmative determination in block 516), the process continues with one or more of the remaining training iterations to obtain kernel training data to build the kernels (block 517).

On the other hand, if the kernel training process determines that acceptable margins cannot be achieved for the remaining kernels (negative determination in block 516), the kernel training process can be modified in way that could facilitate building the remaining kernels with acceptable margins. For example, in circumstances where all of the original prespecified number of iterations of the kernel training process have been completed, the kernel training process can determine to continue with additional training iterations while keeping other metrics/parameters of the training process the same. By way of example, assume that the kernel training process was configured to perform 10K training iterations (including a specified number of parallel training iterations and/or single training iterations), the kernel training process can determine that an additional number of training iterations (e.g., 2K, 5K, etc.) would possibly result in successfully building all remaining kernels with acceptable margins. The additional training iterations could include single training iterations, parallel training iterations, or a combination of both.

Moreover, in circumstances where the kernel training process determines that acceptable margins cannot be achieved for the remaining kernels (negative determination in block 516) at some point in time (i) when all of the original prespecified number of iterations of the kernel training process have been completed, or (ii) before all the original specified number of iterations of the kernel training process have been completed, the kernel training process can proceed to terminate the current kernel training process and record data associated with the current kernel training process (block 518), adjust one or more metrics of the kernel training process (block 519), and restart a new kernel training process based on the adjusted metrics (block 520). For example, if the kernel training process determines that process is not approaching the target threshold for at least some of the kernels for corresponding qubits, the kernel training process can be modified by adjusting the specified target threshold metric to achieve a level of acceptable outcomes. Moreover, the kernel training process can be adjusted by modifying the seed that is utilized to generate the pseudo random numbers for the parallel training iterations. Moreover, the kernel training process can be adjusted by modifying the number of training iterations to be performed, including the modifying the number of single training iterations and/or number of parallel training iterations. The record data process (block 518) involves persistently storing all the data associated with the training process, e.g., number of iterations, margins obtained for all the kernels, other training metrics specified for given kernel training process, etc. The data recordation facilitates a comparison between various training kernel processes (successful and unsuccessful) performed on the same quantum system or different quantum systems, etc.

As previously noted, in some embodiments, the exemplary kernel training process of FIGS. 5A and 5B can be implemented in software as a computer simulated kernel training process. In other embodiments, the exemplary kernel training process of FIGS. 5A and 5B can be implemented in hardware on a given quantum computing system in which a kernel training process executing on a classical computing device issues instructions (i) a qubit control system configured to generate qubit control signals to set individual states of physical qubits in a given multiplexed group of qubits, and (ii) a qubit readout control system configured to generate qubit readout control signals to perform frequency-multiplexed readout of groups of physical qubits.

In other embodiments, a kernel training process can be implemented by (i) performing a computer simulated kernel training process to determine a simulated training protocol which results in the generation of kernels that have acceptable margins for state discrimination of a multiplexed group of qubits, and (ii) applying the parameters of the simulated training protocol to configure a hardware kernel training process using a quantum computing system which supports frequency-multiplexed readout of groups of qubits.

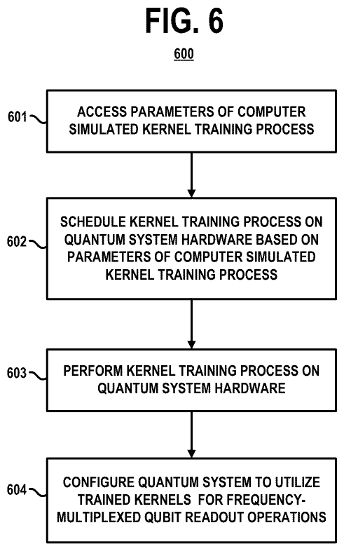

For example, FIG. 6 illustrates a flow diagram of a method for training a group of kernels that are configured to analyze frequency-multiplexed readout signals for a group of qubits to discriminate quantum states of the qubits, according to another exemplary embodiment of the disclosure. In particular, FIG. 6 illustrates an exemplary process flow for performing a hardware-based kernel training process 600 which is configured using parameters of a computer simulated kernel training process, according to an exemplary embodiment of the disclosure. With the process shown in FIG. 6 it is assumed that a computer simulated kernel training process was performed on a computer simulated frequency-multiplexed qubit readout system with one or more groups of qubits corresponding to a given quantum computing system, and that the computer simulated kernel training process yielded a set of training kernels having acceptable margins for state discrimination of the one or more simulated groups of qubits.

The parameters of the computer simulated kernel training process are accessed and utilized as a baseline for configuring the hardware kernel training process to essentially emulate the computer simulated training process (block 601). For example, the computer simulated kernel training process will provide a given order or schedule for performing the same or similar computer simulated training iterations on the hardware system. For example, the computer simulated kernel training process will specify, e.g., a given total number of training iterations including the type of iterations (single and parallel training iteration) and the number of such iterations, the scheduling the order of such iterations, the states of the qubits for each parallel training iteration (e.g., |0 [symbol] state, |1 [symbol] state, or inactive state X), etc. In this regard, the kernel training process on the quantum system hardware can be scheduled and configured based on the parameters of the computer simulated kernel training process (e.g., the computer simulated schedules can be incorporated into the quantum computing code for controlling the qubit control and readout hardware) to essentially emulate the computer simulated training process on the quantum system hardware (block 602).

Next, a kernel training process is performed using the quantum system hardware (block 603). In some embodiments, the kernel training process is performed on hardware using the exemplary kernel training process of FIGS. 5A and 5B, but slightly modified for implementation on hardware, as discussed above. Following the kernel training process, the frequency-multiplexed qubit readout system of the quantum computing system is configured to utilize a resulting set of trained kernels for a given multiplexed group of qubits, which have acceptable margins for discriminating the computational basis states of |0 [symbol] and |1 [symbol] the qubits (block 604).

It is to be appreciated that there are various advantages to utilizing a computer simulated kernel training process to configure a corresponding hardware kernel training process for training sets of kernels for corresponding groups of multiplexed qubits. For example, performing a computer simulated kernel training process on, e.g., a personal computer, is very fast, where a computer training process with 10K or more training iterations can be completed on the order of minutes, whereas a hardware kernel training process performed on quantum computing system can be significantly longer, e.g., on the order of hours. Moreover, multiple computer simulated kernel training processes can be performed as needed, in a relatively short time, to achieve a good baseline for scheduling a corresponding hardware-based kernel training process. Indeed, performing a hardware-based kernel training process on a quantum system leads to downtime of the quantum computing system for use in performing other quantum computing tasks. Such downtime is increased when using a hardware-based kernel training process alone without using baseline parameters that are determined by performing computer simulated kernel training processes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

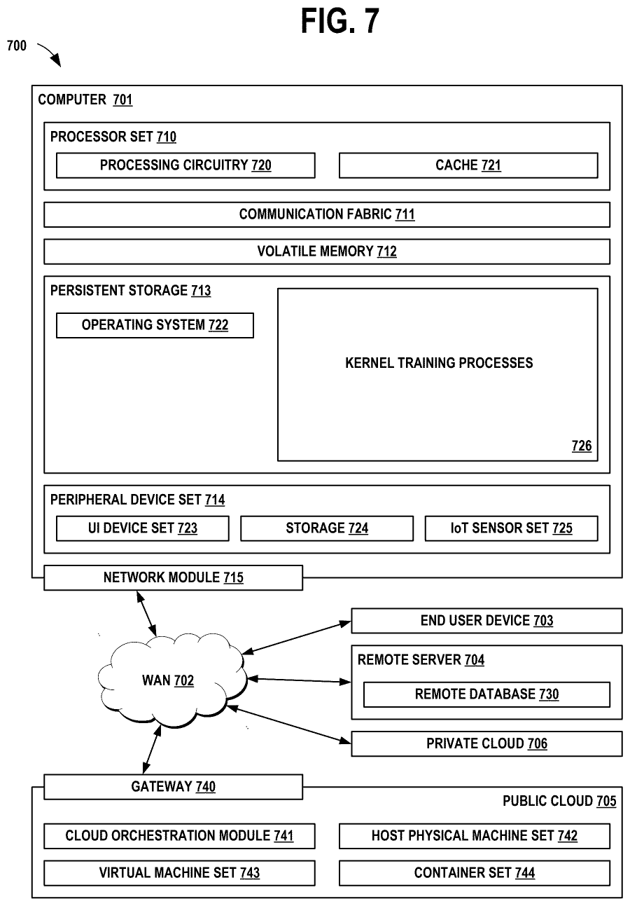

FIG. 7 schematically illustrates an exemplary architecture of a computing environment 700 that is configured to implement kernel training methods, according to an exemplary embodiment of the disclosure. Computing environment 700 of FIG. 7 contains an example of an environment for the execution of at least some of the computer code (block 726) involved in executing kernel training process for building a group of kernels that are trained to analyze frequency-multiplexed readout signals for a group of qubits to discriminate quantum states of the qubits, as discussed herein. In addition to block 726, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 726, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 726 in persistent storage 713.

Communication fabric 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open source Portable Operating System Interface type operating systems that employ a kernel. The code included in block 726 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

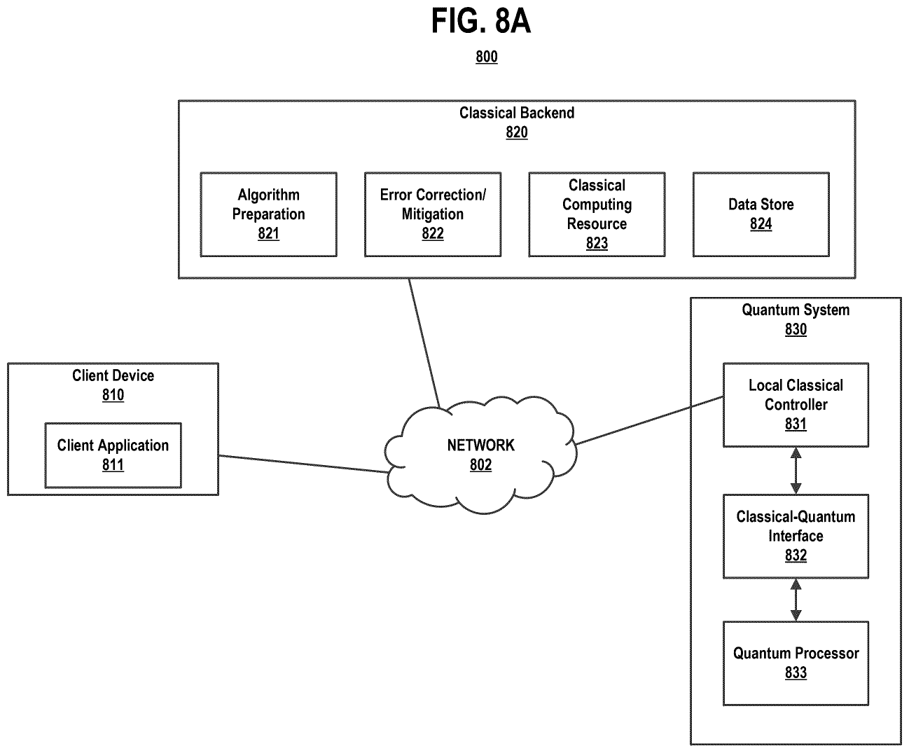

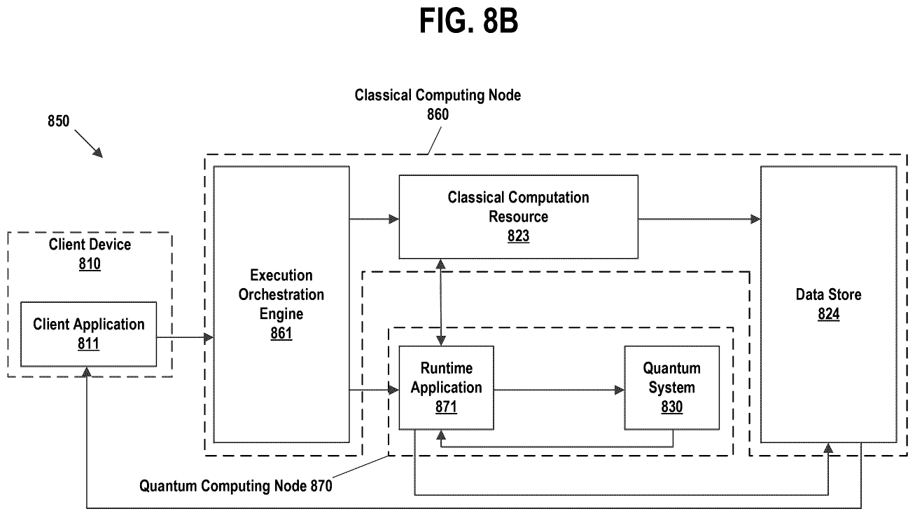

FIG. 8A is a schematic block diagram of an exemplary hybrid computing system 800 that can be configured to implement kernel training methods to facilitate frequency-multiplexed readout of quantum states of superconducting qubits, according to an exemplary embodiment of the disclosure. As shown, a client device 810 may interface with a classical backend 820 to enable computations with the aid of a quantum system 830.

Network 802 may be any combination of connections and protocols that will support communications between the client device 810, the classical backend 820, and the quantum system 830. In an example embodiment, network 802 may be the WAN 702.

Client device 810 may be an implementation of computer 701 or EUD 703, as described in FIG. 7, and configured to operate in a hybrid computing system 800.

Client application 811 may include an application or program code that includes computations requiring a quantum algorithm, a quantum operation, or a client application that is configured to perform kernel training methods as discussed herein. In an embodiment, client application 811 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 811 may include machine level instructions for performing a quantum circuit, such as OpenQASM. Additionally, user application may be any other high-level interface, such as a graphical user interface, having the underlying object oriented and/or machine level code as described above.

In some embodiments, the classical backend 820 is an implementation of the computer 701 of FIG. 7, as described above, having program modules configured to operate in a hybrid computing system 800. Such program modules for classical backend 820 may include algorithm preparation 821, classical computing resource 823, and data store 824.

Algorithm preparation 821 may be a program or module capable of preparing algorithms contained in client application 811 for operation on quantum system 830. Algorithm preparation 821 may be instantiated as part of a larger algorithm, such as a function call of an API, or by parsing a hybrid classical-quantum computation into aspects for quantum and classical calculation. Algorithm preparation 821 may additionally compile or transpile quantum circuits that were contained in client application 811 into an assembly language code for use by the local classical controller 831 to enable the quantum processor 833 to perform the logical operations of the circuit on physical structures. During transpilation/compilation an executable quantum circuit in the quantum assembly language may be created based on the calculations to be performed, the data to be analyzed, and the available quantum hardware. In one example embodiment, algorithm preparation 821 may select a quantum circuit from a library of circuits that have been designed for use in a particular problem. In another example embodiment, algorithm preparation 821 may receive a quantum circuit from the client application 811 and may perform transformations on the quantum circuit to make the circuit more efficient, or to fit the quantum circuit to available architecture of the quantum processor 833. Additionally, algorithm preparation 821 may prepare classical data from data store 824, or client application 811, as part of the assembly language code for implementing the quantum circuit by the local classical controller 831. Algorithm preparation 821 may additionally set the number of shots (i.e., one complete execution of a quantum circuit) for each circuit to achieve a robust result of the operation of the algorithm. Further, algorithm preparation 821 may update, or re-compile/re-transpile, the assembly language code based on parallel operations occurring in classical computing resource 823 or results received during execution of the quantum calculation on quantum system 830. Additionally, algorithm preparation 821 may determine the criterion for convergence of the quantum algorithm or hybrid algorithm.

Error correction/mitigation 822 may be a program or module capable of performing error correction or mitigation techniques for improving the reliability of results of quantum computations. Error correction is the most basic level of error handling. Error suppression refers to techniques where knowledge about the undesirable effects of quantum hardware is used to introduce customization that can anticipate and avoid the potential impacts of those effects, such as modifying signals from Classical-quantum interface 832 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 823 may be a program or module capable of performing classical (e.g., binary, digital) calculations contained in client application 811. Classical calculations may include formal logical decisions, AI/ML algorithms, floating point operations, and/or simulation of Quantum operations.

Data store 824 may be a repository for data to be analyzed using a quantum computing algorithm, as well as the results of such analysis. Data store 824 may be an implementation of storage 724 and/or remote database 730 (FIG. 7), configured to operate in a hybrid computing system 800.

The quantum system 830 can be any suitable set of components capable of performing quantum operations on a physical system. In the example embodiment depicted in FIG. 8A, quantum system 830 includes a local classical controller 831, a classical-quantum interface 832, and quantum processor 833. In some embodiments, all, or part of each of the local classical controller 831, a classical-quantum interface 832, and quantum processor 833 may be located in a cryogenic environment to aid in the performance of the quantum operations. In some embodiments, the classical backend 820 and the quantum system 830 may be co-located to reduce the communication latency between the devices.

Local classical controller 831 may be any combination of classical computing components capable of aiding a quantum computation, such as executing one or more quantum operations to form a quantum circuit, by providing commands to a classical-quantum interface 832 as to the type and order of signals to provide to the quantum processor 833. Local classical controller 831 may additionally perform other low/no latency functions, such as error correction, to enable efficient quantum computations. Such digital computing devices may include processors and memory for storing and executing quantum commands using classical-quantum interface 832. Additionally, such digital computing devices may include devices having communication protocols for receiving such commands and sending results of the performed quantum computations to classical backend 820. Additionally, the digital computing devices may include communications interfaces with the classical-quantum interface 832. In an embodiment, local classical controller 831 may include all components of the computer 701 (FIG. 7), or alternatively may be individual components configured for specific quantum computing functionality, such as processor set 710, communication fabric 711, volatile memory 712, persistent storage 713, and network module 715 (FIG. 7).

Classical-quantum interface 832 may be any combination of devices capable of receiving command signals from local classical controller 831 and converting those signals into a format for performing quantum operations on the quantum processor 833. Such signals may include electrical (e.g., RF, microwave, DC) or optical signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 832 may be capable of converting signals received from the quantum processor 833 into digital signals capable of processing and transmitting by local classical controller 831 and classical backend 820. Such signals may include qubit state readouts. Devices included in classical-quantum interface 832 may include, but are not limited to, digital-to-analog converters, analog-to-digital converters, waveform generators, attenuators, amplifiers, filters, optical fibers, and lasers.

Quantum processor 833 may be any hardware capable of using quantum states to process information. Such hardware may include a collection of qubits, mechanisms to couple/entangle the qubits, and any required signal routings to communicate between qubits or with classical-quantum interface 832 in order to process information using the quantum states. Such qubits may include, but are not limited to, charge qubits, flux qubits, phase qubits, spin qubits, and trapped ion qubits. The architecture of quantum processor 833, such as the arrangement of data qubits, error correcting qubits, and the couplings amongst them, may be a consideration in performing a quantum circuit on quantum processor 833.

In some embodiments, the algorithm preparation 821 comprises a program or module that is configured to implement the exemplary quantum circuit synthesis methods as discussed herein for synthesizing quantum state initialization circuits for preparing superposed states of quantum bit registers, which can be utilized in conjunction with many types of quantum computing algorithms (e.g., ground state energy estimation algorithms) which utilize initialized superposed quantum states of quantum bit registers to perform associated quantum computations. For example, in some embodiments, the algorithm preparation 821 comprises a program or module that is configured to implement a method for generating a quantum circuit for performing hardware-based kernel training methods as discussed herein, where kernel training schedules are incorporated into program code for perform multiple iterations of a kernel training process. The local classical controller 831 of the quantum system 830 is configured to process and execute such quantum state initialization circuits to prepare initial superposed states of quantum bit registers in an array of quantum bits of the quantum processor 833, and to process and execute associated quantum computing algorithms (e.g., ground state energy estimation algorithms) which utilize the initialized superposed quantum states of the quantum bit registers to perform associated quantum computations.

Advantageously, the exemplary quantum state initialization circuits for preparing superposed states of quantum bit registers provide significant improvements to computer functionality as well as technical improvements to existing technological processes for generating superposed states of quantum bit registers. For example, the exemplary quantum circuit synthesis techniques are generated configured to generate quantum state initialization circuits that are both depth-efficient and use the minimal number of unique layers. This has a multiplicative effect in enhancing both computer performance and the efficiency and accuracy of quantum computing algorithms. The exemplary quantum state initialization circuits allow for a reduction in the decoherence experienced during quantum circuit execution, allow for error mitigation to increase algorithmic performance, and allow for a reduction in the total runtime by minimizing the number of layers and required experiments.

For example, advanced error mitigation methods, such as Probabilistic Error Cancellation and Zero Noise Extrapolation, need to learn a noise model associated with, e.g., the unique controlled-NOT (CX) layers of a state initialization quantum circuit. In this regard, the exemplary techniques as described herein for synthesizing quantum state initialization circuits are configured to minimize the number of unique CX-layers, thus enhancing the functionalities of advanced error mitigation methods, such as Probabilistic Error Cancellation and Zero Noise Extrapolation. Indeed, a larger number of CX-layers not only increases the computer runtime, but also increases a risk of failure because noise of the quantum device (e.g., quantum processor) might drift away from the learned noise model. The exemplary quantum state initialization circuit synthesis techniques as described herein are configured to fix and minimize the number of CX-layers of a state initialization quantum circuit based on the number of unique colors of a corresponding edge-colored connectivity graph.

Referring now to FIG. 8B, a block diagram is depicted showing an exemplary architecture, and data transmission, of a hybrid computation system 850 employed using a cloud architecture for classical backend 820. Hybrid computation system 850 receives an algorithm containing a computation from a client application 811 of client device 810. Upon receipt of the algorithm and request from client application 811, hybrid computation system 850 instantiates a classical computing node 860 and a quantum computing node 870 to manage the parallel computations. The classical computing node 860 may include one or more classical computers capable of working in tandem (e.g., utilizing the cloud computing environment described with reference to FIG. 7). For example, classical computing node 860 may include an execution orchestration engine 861, one or more classical computation resources 823, and a data store 824. The quantum system 830 may include a combination of classical and quantum computing components acting together to perform quantum calculations on quantum hardware including, for example, one or more quantum systems 830. The quantum computing node 870 may include a quantum runtime application 871 and one or more quantum systems 830.

The client application 811 may include programing instructions to perform quantum and classical calculations. In an embodiment, client application 811 may be in a general-purpose computing language, such as an object-oriented computing language (e.g., Python®), that may include classical and quantum functions and function calls. This may enable developers to operate in environments they are comfortable with, thereby enabling a lower barrier of adoption for quantum computation.

The execution orchestration engine 861, in using algorithm preparation 821, may parse the client application 811 into a quantum logic/operations portion for implementation on a quantum computing node 870, and a classical logic/operations portion for implementation on a classical computing node 860 using a classical computation resource 823. In an embodiment, parsing the client application 811 may include performing one or more data processing steps prior to operating the quantum logic using the processed data. In an embodiment, parsing the client application 811 may including segmenting a quantum circuit into portions that are capable of being processed by quantum computing node 870, in which the partial results of each of the segmented quantum circuits may be recombined as a result to the quantum circuit. Execution orchestration engine 861 may parse the hybrid algorithm such that a portion of the algorithm is performed using classical computation resources 823 and a session of quantum computing node 870 may open to perform a portion of the algorithm. The quantum runtime application 871 may communicate, directly or indirectly, with classical computation resources 823 by sending parameters/information between the session to perform parallel calculations and generate/update instructions of quantum assembly language to operate quantum system 830, and receiving parameters/information/results from the session on the quantum system 830. Following the parsing of the hybrid algorithm for calculation on quantum computing node 870 and classical computing node 860, the parallel nodes may iterate the session to convergence by passing the results of quantum circuits, or partial quantum circuits, performed on quantum system 830 to classical computing resource 823 for further calculations. Additionally, runtime application 871, using algorithm preparation 821, may re-parse aspects of the hybrid algorithm to improve convergence or accuracy of the result. Such operation results, and progress of convergence, may be sent back to client device 810 as the operations are being performed. By operating execution orchestration engine 861 in a cloud environment, the environment may scale (e.g., use additional computers to perform operations necessary) as required by the client application 811 without any input from the creators/implementors of client application 811. Additionally, execution orchestration engine 861, while parsing the client application 811 into classical and quantum operations, may generate parameters, function calls, or other mechanisms in which classical computation resource 823 and quantum computing node 870 may pass information (e.g., data, commands) between the components such that the performance of the computations enabled by client application 811 is efficient.

Classical computation resources 823 may perform classical computations (e.g., formal logical decisions, AI/ML algorithms, floating point operations, simulation of Quantum operations) that aid/enable/parallelize the computations instructed by client application 811. By utilizing classical computation resources 823 in an adaptively scalable environment, such as a cloud environment, the environment may scale (e.g., use additional computers to perform operations necessary including adding more classical computing resources 823, additional quantum systems 830, and/or additional resources of quantum systems 830 within a given quantum computing node 870) as required by the client application 811 without any input from the creators/implementors/developers of client application 811, and may appear seamless to any individual implementing client application 811 as there are no required programming instructions in client application 811 needed to adapt to the classical computation resources 823. Thus, for example, such scaling of quantum computing resources and classical computing resources may be provided as needed without user intervention. Scaling may reduce the idle time, and thus reduce capacity and management of computers in classical computing node 860.

The data store 824 may store, and return to client device 810, states, configuration data, etc., as well as the results of the computations of the client application 811.

Implementation of the systems described herein may enable hybrid computing system 800, through the use of quantum system 830, to process information, or solve problems, in a manner not previously capable. The efficient parsing of the quantum or hybrid algorithm into classical and quantum segments for calculation may achieve efficient and accurate quantum calculations from the quantum system 830 for problems that are exponentially difficult to perform using classical backend 820. Additionally, the quantum assembly language created by classical backend 820 may enable quantum system 830 to use quantum states to perform calculations that are not classically efficient or accurate. Specifically, as noted above, the exemplary quantum circuit synthesis techniques for preparing superposed states can be applied to various quantum computing tasks where gate-efficient state preparation needs to be combined with advanced mitigation methods like PEC and ZNE. For example, the methods can be used to generate GHZ states, and to estimate the ground state of quantum many-body systems. The exemplary methods can generate superposed states, such as the checkerboard and GHZ states, which are useful initial states in circuits for estimating ground state energies for many-body systems. In addition, the exemplary techniques discussed herein for synthesizing superposed state circuits and reducing the number of the unique gate layers, are advantageously useful for efficiently learning and effectively mitigating quantum noise using advanced mitigation methods such as PEC and ZNE. In addition, the exemplary techniques described herein provide systems and methods for high density synthesis of a quantum state preparation circuit of superposed states, wherein quantum synthesis algorithms enable the construction of quantum circuits with a small depth and a minimal number of unique gate layers. Such technical improvements may reduce the classical resources required to perform the calculation of the quantum or hybrid algorithm, by improving the capabilities of the quantum system 830.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
performing multiple iterations of a process which comprises:
setting states of a group of quantum bits using a random process; and
performing a readout process to acquire a frequency-multiplexed readout signal which represents readout states of the group of quantum bits; and
analyzing the frequency-multiplexed readout signals acquired for at least a portion of the iterations to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

2. The method of claim 1, wherein setting the states of the group of quantum bits using a random process comprises randomly setting the state of a given quantum bit to be one of a ground state, an excited state, and an inactive state.

3. The method of claim 1, wherein the random process is implemented using a pseudo random number generator.

4. The method of claim 1, wherein the random process is implemented using a true random number generator.

5. The method of claim 1, wherein performing multiple iterations of the process further comprises performing multiple iterations of a single quantum bit readout process which comprises:
setting the state of a single quantum bit of the group of quantum bits to a given computational basis state; and
performing a readout process to acquire a readout signal which represents the readout state of the single quantum bit.

6. The method of claim 1, wherein the at least one kernel for each quantum bit comprises a digital representation of a sinusoidal waveform having a frequency that corresponds to a readout resonator that is associated with the quantum bit.

7. The method of claim 1, wherein analyzing the frequency-multiplexed readout signals acquired for at least a portion of the iterations to build at least one kernel for each quantum bit of the group of quantum bits, comprises:
determining a first subset of the iterations in which a given qubit was set to a ground state;
determining a second subset of the iterations in which the given qubit was set to an excited state;
computing a first average of the frequency-multiplexed readout signals acquired in the first subset of the iterations;
computing a second average of the frequency-multiplexed readout signals acquired in the second subset of the iterations; and
building the at least one kernel for the given qubit based on the computed first average and the computed second average.

8. The method of claim 7, wherein building the at least one kernel for the given qubit comprises determining the at least one kernel based at least in part on a difference between the computed first average and the computed second average.

9. A computer program product for performing a process to train kernels for use in frequency-multiplexed readout of quantum bits, the computer program product comprising:
one or more computer readable storage media, and program instructions collectively stored on the one or more computer readable storage media, the program instructions comprising:
program instructions to perform multiple iterations of a process which comprises:
setting states of a group of quantum bits using a random process; and
performing a readout process to acquire a frequency-multiplexed readout signal which represents readout states of the group of quantum bits; and
program instructions to analyze the frequency-multiplexed readout signals acquired for at least a portion of the iterations to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

10. The computer program product of claim 9, wherein the program instructions for setting the states of the group of quantum bits using a random process comprises program instructions to randomly set the state of a given quantum bit to be one of a ground state, an excited state, and an inactive state.

11. The computer program product of claim 9, wherein the random process is implemented using a pseudo random number generator.

12. The computer program product of claim 9, wherein the random process is implemented using a true random number generator.

13. The computer program product of claim 9, wherein the program instructions to perform multiple iterations of the process further comprise program instruction to perform multiple iterations of a single readout process which comprises:
setting the state of a single quantum bit of the group of quantum bits to a given computational basis state; and
performing a readout process to acquire a readout signal which represents the readout state of the single quantum bit.

14. The computer program product of claim 9, wherein the at least one kernel for each quantum bit comprises a digital representation of a sinusoidal waveform having a frequency that corresponds to a readout resonator that is associated with the quantum bit.

15. The computer program product of claim 9, wherein the program instructions to analyze the frequency-multiplexed readout signals acquired for at least a portion of the iterations to build at least one kernel for each quantum bit of the group of quantum bits, comprise:
program instructions to determine a first subset of the iterations in which a given qubit was set to a ground state;
program instructions to determine a second subset of the iterations in which the given qubit was set to an excited state;
program instructions to compute a first average of the frequency-multiplexed readout signals acquired in the first subset of the iterations;
program instructions to compute a second average of the frequency-multiplexed readout signals acquired in the second subset of the iterations; and
program instruction to build the at least one kernel for the given qubit based on the computed first average and the computed second average.

16. The computer program product of claim 15, wherein the program instructions to build the at least one kernel for the given qubit comprise program instructions to determine the at least one kernel based at least in part on a difference between the computed first average and the computed second average.

17. The computer program product of claim 9, further comprising program instructions to configure a kernel training process on a quantum computing system comprising a group of physical quantum bits with corresponding readout resonators that are coupled to a shared readout bus to train kernels for use in frequency-multiplexed readout of the group of physical quantum bits, based on parameters of a computer simulated kernel training process.

18. A device, comprising:
memory that is configured to store program instructions; and
processing circuitry, coupled to the memory, and configured to execute the program instructions to train kernels for use in frequency-multiplexed readout of quantum bits, the training comprising:
performing multiple iterations of a process which comprises:
setting states of a group of quantum bits using a random process; and
performing a readout process to acquire a frequency-multiplexed readout signal which represents readout states of the group of quantum bits; and
analyzing the frequency-multiplexed readout signals acquired for at least a portion of the iterations to build at least one kernel for each quantum bit of the group of quantum bits, wherein the at least one kernel for a given quantum bit is configured for use in discriminating a state of the given quantum bit in a frequency-multiplexed readout operation applied to the group of quantum bits.

19. The device of claim 18, wherein setting the states of the group of quantum bits using a random process comprises randomly setting the state of a given quantum bit to be one of a ground state, an excited state, and an inactive state.

20. The device of claim 18, wherein the random process is implemented using at least one of a pseudo random number generator and a true random number generator.
